(19) United States
(12) Patent Application Publication
(10) Pub. No.: US 2026/0349692 A1
(43) Pub. Date: Nov. 5, 2026

(54) Artificial Intelligence Agents with Persistent Learning

(71) Applicant: ServiceNow, Inc., Santa Clara, CA (US)

(72) Inventors: Amine El Hattami, Zürich (CH); André Michel Milton, Montreal (CA); Kyle Barron-Kraus, East Lansing, MI (US); Eric Labouve, San Diego, CA (US); Megh Vipul Thakkar, Montreal (CA); Rahul Mathur, Hyderabad (IN); Jingfei Chen, San Francisco, CA (US); Daniel Sutoyo, San Diego, CA (US); Michael Denman, San Diego, CA (US); Payal Bhujwala, Hyderabad (IN)

(21) Appl. No.: 19/576,894

(22) Filed: Mar. 24, 2026

Related U.S. Application Data
(60) Provisional application No. 63/799,134, filed on May 2, 2025.
(60) Provisional application No. 63/836,130, filed on Jun. 30, 2025.

(51) Int. Cl. G06F 8/41; G06F 16/3329

(52) U.S. Cl. CPC G06F 8/433; G06F 16/3329

(57) ABSTRACT

Embodiments are provided that include (i) recording an artificial intelligence (AI) agent interacting with a user interface, with the interaction including the AI agent performing a plurality of actions of a first task; (ii) based on the recording, identifying capabilities of the AI agent associated with the AI agent performing the plurality of actions of the first task; (iii) receiving a natural language request to perform a second task; and (iv) in response to receiving the natural language request: (a) generating a flow based on a representation of a subset of the capabilities; and (b) executing the flow in order to perform the second task. This allows the AI agent's performance of the first task to benefit subsequent tasks without incurring the substantial computational cost of executing such an agent that is able to interact generically with the user interface.

### CROSS-REFERENCE TO RELATED APPLICATIONS

This application calls priority to U.S. provisional application No. 63/799,134, filed May 2, 2025, and U.S. provisional application No. 63/836,130, filed Jun. 30, 2025, the contents of which are hereby incorporated by reference.

### BACKGROUND

Machine learning (ML) models or other types of artificial intelligence (AI) models can be used for implementing ‘agents,’ navigating user interfaces (e.g., web-based interfaces), sending and receiving data via application programming interfaces (“API”'s, e.g., an API for interacting with a cloud computing environment), or performing other actions in order to accomplish one or more commanded tasks. Such models can be multi-modal, allowing them to ingest images (e.g., rendered images of web pages), text (e.g., HTML of web pages, textual returns from API calls), or other modalities of information to accomplish one or more tasks. However, such models may be computationally expensive to train and execute (e.g., with respect to processor cycles, memory use, network interconnect utilization, and/or power). Additionally, the performance of complex tasks may include the performance of many actions, and thus many executions of such a model. In such examples, multiple agents may be used, e.g., with different agents specializing in the performance of different tasks and/or different aspects of a single task. It would be beneficial to achieve the benefits of such models or sets of models while reducing these computational costs.

### SUMMARY

Autonomous agents (e.g., agents that include one or more trained artificial intelligence (“AI”) models or other type of trained machine learning models) can be used to perform a variety of tasks. In some examples, more complex tasks may be performed by executing such an agent multiple times, e.g., with the results of previous actions taken by the agent (e.g., machine-executable instructions extracted from prior AI model outputs and executed in a user interface, API, or other action environment) appended to the input, to provide the agent with memory. The embodiments described herein include specific types of multi-agent networks, wherein specific agents of the network perform respective different functions and interact with each other (e.g., providing inputs/outputs) in specific ways to provide improvements with respect to the accuracy, computational cost, and other aspects of the completion of tasks by such autonomous systems.

In some examples, this can include a first AI agent (e.g., a “planner” model) generating a workflow or other type of flow that specifies a plurality of actions or information to complete a specified task (e.g., in response to a natural language user request to perform the specified task). Such a flow could be composed of a plurality of capabilities or other representations of individual sub-tasks (e.g., specified as machine-executable code which may be natively executable in an API, command line, or other action environment to accomplish the sub-task). A second AI agent (e.g., an “executor” model) could receive the flow and then act to accomplish the task by, e.g., causing the performance of each sub-task thereof (e.g., according to an ordering and/or graph of interdependencies between capabilities represented in the flow).

In some examples, such an “executor” AI agent could act to manage the operation of one or more other AI agents (e.g., multi-modal models capable of interacting with webpages or other graphical user interfaces based, at least in part, on images of the state of such interfaces). For example, the executor AI agent could be or include an LLM or other text-based model and could operate to evaluate the performance of sub-tasks by a second AI agent (e.g., a multi-model model), requesting re-performance of failed sub-tasks (e.g., by modifying the prompt that was previously provided, based in part on the output of the previous unsuccessful attempt), generating prompts or other instructions for the second AI agent to perform subsequent tasks, and/or performing some other operations related to the performance of a flow or other multi-action task. In some examples, the capabilities or other components of a flow could be labelled as deterministic or otherwise likely to be successfully performed if executed directly (e.g., in a command line, API, HTML request, or other action environment rather than indirectly through the use of an AI agent to interact with GUI(s) or other interfaces). In such examples, such an executor AI agent could first attempt to perform such deterministic capabilities directly (e.g., by executing machine-executable content thereof in the appropriate command line, API, or other action environment). In the event that such direct execution fails (determined, e.g., by the executor model operating to evaluate the results of such direct execution), the executor model could then formulate a prompt or other instruction (e.g., by appending additional instructions, the results of the failed attempt, or other information to a representation of the contents of the deterministic capability) for a second AI agent to attempt to perform the capability.

Various implementations disclosed herein provide a technical solution to these problems by, among other things, dividing the performance of complex, multi-step tasks across multiple agents, which may be or include AI agents. Such separation allows the models themselves and/or the prompts thereto to be adapted to improve their performance with respect to the different aspects of the overall task performance (e.g., to improve one agent for task planning, another for executing and evaluation of attempted sub-tasks according to such a plan, and a third for performing sub-tasks within complex GUIs or other multi-modal action environments which may behave less deterministically). Additionally, by separating the performance of complex tasks into individual sub-tasks (which may be represented as capabilities as described elsewhere herein) whose performance and evaluation are performed by different AI agents, failed sub-tasks can be detected and re-attempted without incurring the time and computational cost of re-attempting the entire task.

Multi-modal or other varieties of trained AI models can be effective at performing a variety of tasks by navigating web interfaces, interacting with systems via APIs, and/or performing other actions. Generally, as the quality of such models increases (e.g., with respect to their efficacy in performing tasks and their accuracy in hewing to the specific constraints of commanded tasks, including their ability to ‘plan’ and execute multi-step tasks), the computational costs to load, maintain, train, and execute such models also increase. For example, a larger model may ‘know’ about a broader variety of technical or other topics, and so may be able to perform a broader range of tasks. However, such a larger model may also implicate increased costs with respect to processor cycles, memory footprint, network interconnect utilization, power, or other computational costs of execution. These costs can be increased significantly for the completion of more complicated tasks, for which the model may be executed many times.

It can be beneficial to distill, from successful performances of various tasks (e.g., by a model-based agent, as above), information about the performance of the tasks, and/or of sub-tasks thereof, that could be re-used to facilitate the performance of subsequent tasks at decreased computational cost. For example, a representation of the performance of one or more prior tasks related to a command could be added as input to an AI model to improve the execution of the command by the model. However, providing such extended inputs can lead to significantly increased computational costs. For example, increased processor cycles, memory footprint, network interconnect utilization, power, or other costs related to, e.g., the use of models with sufficiently wide inputs to accommodate command inputs augmented by representations of one or more past task performances. In such examples, it may also be necessary to select a subset of task records that are relevant to an input command, a matching process that, itself, may be computationally expensive.

Various implementations disclosed herein provide a technical solution to these problems by, among other things, recording the performance of task(s) (e.g., by an AI model agent) in a machine-executable format that represent actions taken via one or more user interfaces to perform the task(s). These records are then used to generate a database of capabilities (e.g., computer-executable functions) corresponding to various sub-tasks that were performed as part of the recorded task(s). Subsequent performance of the stored capabilities can be very fast and computationally inexpensive since the individual capabilities are represented in the machine-executable format. To perform a new task (e.g., to satisfy a command or other natural language representation of a new task), a relevant subset of the capabilities in the database can be identified and then used to create a flow composed of capabilities from the subset (and optionally, additional capabilities). This flow can then be executed (in the process, executing the constituent capabilities thereof) to perform the commanded new task.

Accordingly, a first example embodiment may involve a method that includes: (i) recording an artificial intelligence (AI) agent interacting with a user interface, wherein the interaction includes the AI agent performing a plurality of actions of a first task; (ii) based on the recording, identifying capabilities of the AI agent associated with the AI agent performing the plurality of actions of the first task; (iii) receiving a natural language request to perform a second task; and (iv) in response to receiving the natural language request: (a) generating a flow based on a representation of a subset of the capabilities; and (b) executing the flow in order to perform the second task.

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts aspects of a method for generating a database of capabilities, in accordance with example embodiments.

FIG. 7 depicts aspects of a record of the performance of a task, in accordance with example embodiments.

FIG. 8 depicts aspects of a method for generating, from a record of the performance of a task, capabilities for actions of the task, in accordance with example embodiments.

FIG. 9 depicts aspects of a method for using a database of capabilities to perform a task, in accordance with example embodiments.

FIG. 10A depicts aspects of a method for using a database of capabilities to perform a task, in accordance with example embodiments.

FIG. 10B depicts aspects of a method for using a database of capabilities to perform a task, in accordance with example embodiments.

FIG. 11A depicts aspects of a record of a performance of a task, in accordance with example embodiments.

FIG. 11B depicts aspects of capabilities, in accordance with example embodiments.

FIG. 11C depicts aspects of capabilities, in accordance with example embodiments.

FIG. 11D depicts aspects of capabilities, in accordance with example embodiments.

FIG. 12A depicts aspects of a method, in accordance with example embodiments.

FIG. 12B depicts aspects of a method, in accordance with example embodiments.

FIG. 13 depicts aspects of a method, in accordance with example embodiments.

FIG. 14 depicts aspects of a method, in accordance with example embodiments

FIG. 15 is a flow chart, in accordance with example embodiments.

FIG. 16 is a flow chart, in accordance with example embodiments.

FIG. 17 is a flow chart, in accordance with example embodiments.

FIG. 18 is a flow chart, in accordance with example embodiments.

FIG. 19 depicts aspects of a display, in accordance with example embodiments.

FIG. 20 depicts aspects of a user interface, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved is automatic navigation of websites, APIs, and other user interfaces to satisfy natural language user requests. In practice, this is problematic because such requests, and the user interfaces used to implement them, can be very complex, implicating a broad ability to reason about the world in general and such user interfaces in particular. In some examples, it may be necessary to provide both textual and visual representations of such interfaces in order for an agentic AI model (in such examples, a multi-modal model, to receive visual and textual information) to be able to accurately navigate the user interface and accomplish the commanded task. Accordingly, agentic AI models capable of accomplishing such tasks may be computationally expensive to execute (e.g., with respect to processor cycles, memory footprint, storage needed to maintain model parameters, network interconnect bandwidth to transfer intermediate results between processors, power), and may require execution multiple times in order to accomplish complex tasks (e.g., to provide the model with feedback regarding the performance of sub-tasks).

Another technical problem being solved is converting the performance of tasks by such expensive, broadly competent models into reusable capabilities that can be used by significantly less computationally expensive models (e.g., smaller, text-only natural language models with relatively narrow input widths that can be executed using much less processor cycles, memory, storage, network interconnect bandwidth, power, and/or other computational costs) to competently perform subsequent tasks. In practice, this is problematic because it is difficult to translate the performance of a task by a highly competent and broadly trained model into a representation thereof that can be efficiently ingested or otherwise applied by a less competent model or otherwise less expensive algorithm to improve the competence of the lesser model at performing subsequent tasks. For example, one (or more) past performances of a task by a highly competent model could be recorded and that record then applied in whole as a supplemental, instructive input to a lesser model. However, this requires the lesser model to have a much wider input length, increasing the processor cycles, memory, network interconnect bandwidth, power, or other computational costs of executing the lesser model. Additionally, it can be difficult for such a model to correctly ‘understand’ the essential actions of the past performance and apply that generic understanding to the performance of subsequent tasks.

The embodiments herein distill recordings of past task performance(s) into sets of machine-executable capabilities. These capabilities can then be efficiently selected and composited into flows for the performance of subsequent tasks. By separating the actions taken during the past task performance(s) into separate capabilities, it becomes easier to select, from the set of available capabilities, a subset of most relevant capabilities to a subsequent task. Then, representations of only the relevant capabilities are applied to a model, along with a command for the subsequent task, in order to generate a flow therefrom. Accordingly, the flow-generating model can be much less computationally expensive to execute (e.g., than a highly competent agentic AI model capable of performing generic tasks with unknown user interfaces without the benefit of a database of such capabilities). Additionally, since the set of relevant capabilities is a subset of the available capabilities, the flow-generating model can also have a shorter input length, leading to additional savings with respect to computational cost.

Moreover, the two-stage method described herein for generating capabilities from recordings of task performances provides a reduction with respect to computational cost. By separating the capability generation task into a first recording-partitioning task followed by individual capability-generation tasks based on each partition, less computationally expensive AI model(s) can be used for the tasks, for a given level of competence and/or accuracy.

Further, by partitioning such recordings into simple actions, conventional code-analysis tools can be applied to filter, process, validate, or otherwise analyze the capabilities. Such code analysis tools (e.g., code complexity algorithms) can be implemented via heuristic algorithms, rather than by relatively more computationally expensive machine learning model-based analysis.

Partitioning the actions of recorded past task performances into individual capabilities that are later assembled into flows can also provide computational cost savings when the capabilities fail, e.g., due to changes in the corresponding aspects of a user interface with which the capabilities interact. During execution of a flow, the failure of attempted execution of a particular capability thereof allows computational resources used to correct the failed capability (e.g., the processor cycles, memory, network interconnect bandwidth, power, and/or other computational costs attendant to the execution of a broadly competent multi-modal agentic AI model to attempt to perform a commanded task or sub-task) to be reduced by attempting to perform only the action defined by the failed capability, rather than the entire commanded task (with potentially many individual actions, and corresponding model executions, required to do so).

Another technical problem being solved is improving the performance of complex, multi-step tasks (e.g., flows composed of multiple capabilities, optionally representing dependencies therebetween by graphs or other representations) by dividing aspects of that performance across multiple agents, which may be or include AI agents. By dividing such complex tasks across multiple different AI agents (e.g., across a planner model and an executor model, and/or across an executor model and a multi-model sub-task performance model), the models can be improved (e.g., by additional training, by modifying model architecture to receive multiple modes of input and/or generate multiple modes of output) and/or the prompts applied to the model can be improved. This can be done to improve the various models' performance with respect to the different aspects of the overall task performance. For example, to improve the use of a first AI agent to generate flows or other task plans; to improve the use of a second AI agent for executing such flows (which can include the evaluation of attempted execution of capabilities or other sub-tasks thereof); and/or to improve the use of a third AI agent to performing sub-tasks within complex GUIs or other multi-modal action environments which may behave less deterministically.

Additionally, using a first AI agent to evaluate the performance of individual sub-tasks by a second AI agent can lead to significant savings with respect to processor cycles, memory use, network interconnect bandwidth use, storage use, power, or other computational costs. This is because the second model's failure to perform specific sub-tasks can be detected and re-attempted without incurring the time and computational cost of re-attempting the entire task. Further, the first model can optionally modify the prompt applied to the second model that lead to the failure (e.g., by the first model generating additional instructions or context based on the failure and/or by appending information about the failed attempt to the prompt), reducing the likelihood that the second model fails to perform the sub-task again.

The use of such an executor AI agent or other type of agent to coordinate and evaluate the performance of individual capabilities or other sub-tasks of a flow or other complex task can also provide technical benefits with respect to the time taken and parallelize-ability of such tasks. This is because such an executor agent can coordinate the performance of multiple sub-tasks at the same time (e.g., such that the performance of multiple different capabilities or other sub-tasks of a flow at least partially overlap in time). The performance of such multiple capabilities in parallel could be done based on a graph or other representation of dependencies therebetween present in a flow or other representation of a task, e.g., where two or more different sub-tasks are not indicated as being dependent upon each other, the two or more different sub-tasks may be performed in parallel. This can reduce the amount of time needed to perform a flow and/or to adapt the time taken to the available computational resources.

Yet further, providing capabilities in a database/in a flow with labels or other metadata indicating whether execution of machine-executable code thereof is likely to result in success can provide savings with respect to time and/or computational costs needed to execute such capabilities. This is because, where such a label or other metadata is available, capabilities that are “likely to result in success” when the machine-executable code thereof is executed (e.g., natively in an API, command line or other machine code-interpreting interface, HTTP connection, or other action environment), such execution can be attempted without incurring the expense of, e.g., inferencing an LLM, multi-modal model, or other expensive AI agent. Where such attempts are unsuccessful, the capability can then be applied (e.g., as part of a prompt) to such an AI agent to attempt to perform the capability again, now with the benefit of the AI agent's competence and ability to adapt to changes in the action interface. Even if a non-zero number of attempts to execute the machine-executable code of “likely to result in success” capabilities end in failure, significant time and computational cost savings will be obtained relative using an AI agent by default.

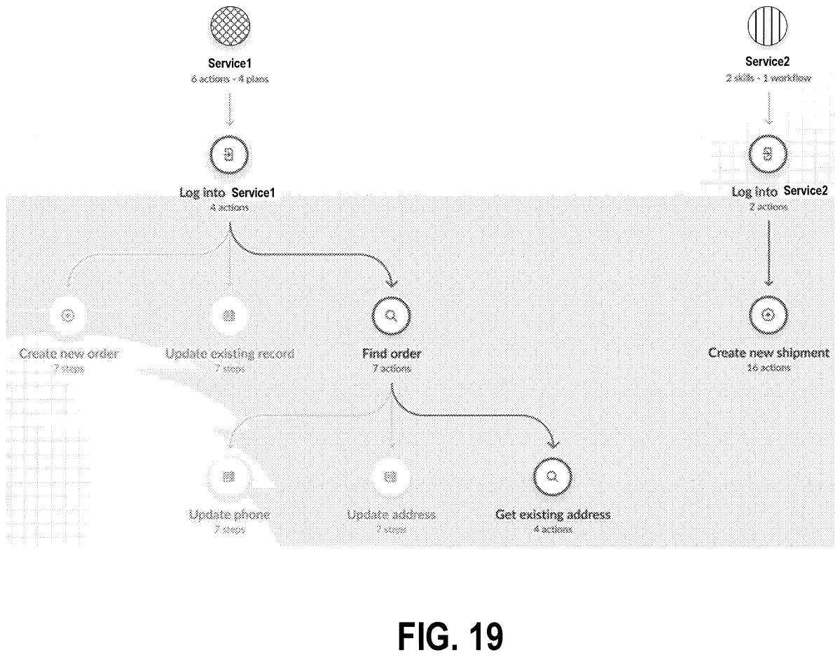

Another benefit of the embodiments described herein is that the relationships between the extracted skills or other capabilities can be readily determined (e.g., during the capability extraction process). For example, the capabilities and/or their use in a flow or recorded session could be sequential and/or cyclical in nature, with clear prerequisite relationships that may determine how they are executed over time. These relationships can inform the use of the capabilities (e.g., by machine learning models or other algorithms to generate flows therefrom) and/or can be displayed to a user. For example, such relationships between capabilities of a generated flow can be displayed to a user, allowing the user to develop, quickly and with minimal effort, a clear understanding of how the AI or other machine learning model reasons, plans, and acts. Such a display (and optionally, approval) process can improve traceability (e.g., users can easily see why a decision was made), predictability (e.g., users can anticipate what a machine learning system will do next), and trustworthiness (e.g., users can feel more confident delegating tasks to a multi-agent system or other machine learning system as described herein). Such display processes can shift a user's perception of the AI or other machine learning system from being a “black box” executor to a more transparent, goal-driven collaborator whose actions can be followed, audited, and understood. FIG. 19 depicts an example of such a display.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

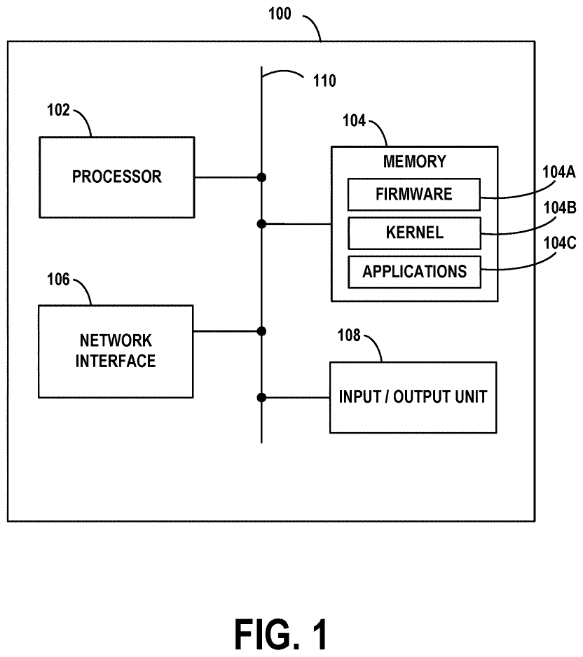

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

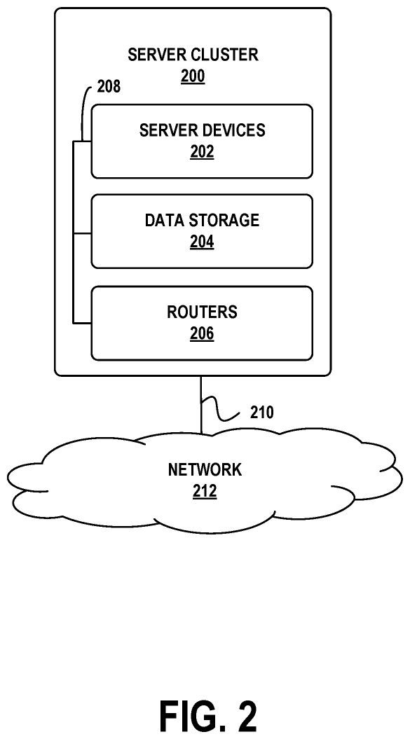

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

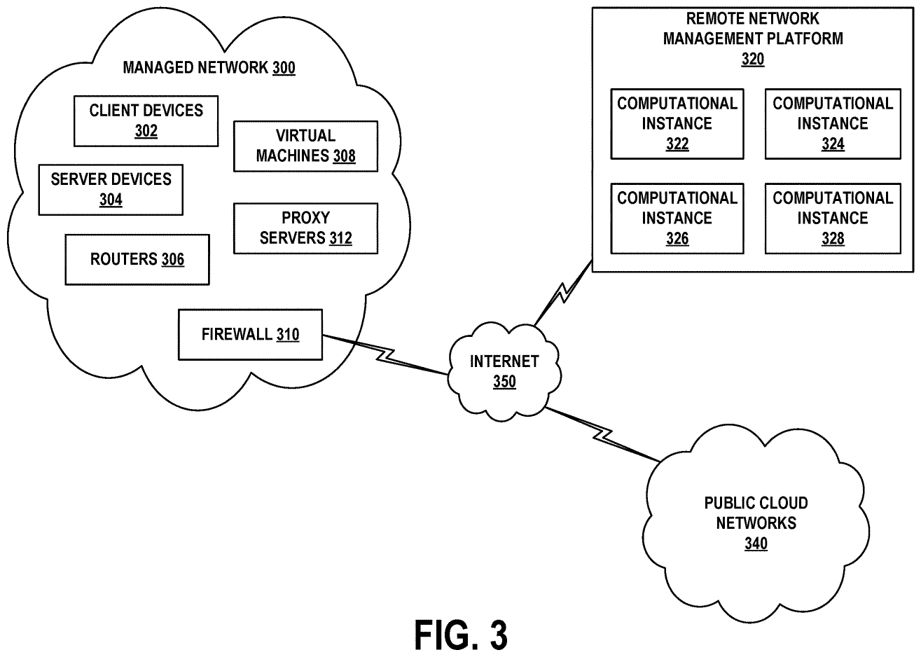

FIG. 3 depicts a remote network management architecture, in accordance with example embodiments. This architecture includes three main components-managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

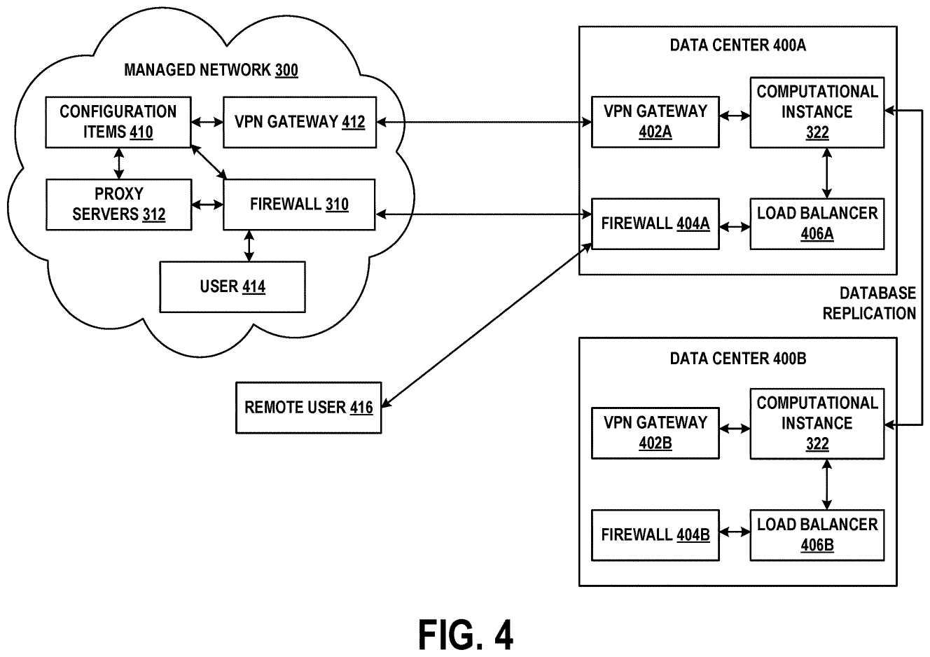

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

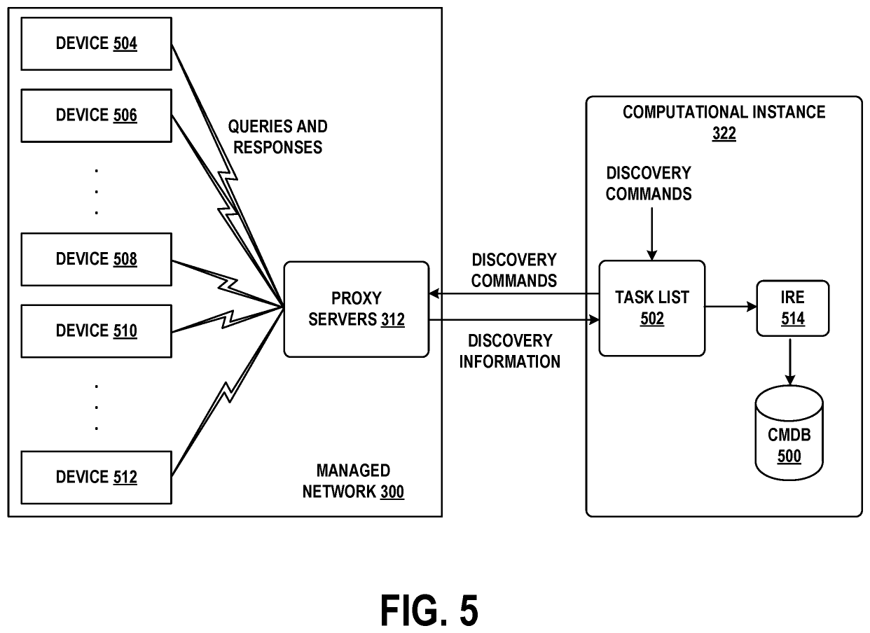

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Example Models

Natural language models are machine learning systems trained to understand, generate, and/or predict human language by learning patterns from large datasets of text and possibly other sources. These models can perform tasks like translation, summarization, question answering, and/or conversation. An LLM is an advanced natural language model, configured to understand, interpret, generate, and respond to human language in a manner that is both contextually relevant and syntactically coherent, allowing even colloquial conversation between a human user and the model.

The underlying structure of an LLM is typically based on a neural network architecture, more specifically, a variant of the transformer model. Transformers are notable for their ability to process sequential data, such as text, with high efficiency. LLM operation involves passing data through layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM's output and expected output.

An aspect of an LLM's functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model's ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and/or produce images and/or audio.

Some LLMs can employ a form of reasoning by transforming user-provided natural language input into a structured internal representation, which is then used to generate a response based on learned statistical associations and contextual dependencies. For complex queries requiring multi-step inference (e.g., mathematical problems, logical deductions, or temporal event analysis), the LLM can decompose the problem into intermediate steps by generating latent representations that reflect intermediate reasoning states. These states are influenced by the training data and are shaped during inference through techniques such as masked self-attention, positional encoding, and next-token prediction, which collectively allow the LLM to simulate deductive or abductive reasoning processes. In some embodiments, explicit chain-of-thought prompting is used to guide the LLM in generating a sequence of intermediate natural language steps, enhancing the LLM's ability to produce structured reasoning outputs. This capability enables the LLM to generate responses that are not merely retrieved facts but the result of multi-step inferential synthesis over the input data and the LLM's internal knowledge representation.

### VIII. Example Generation and Use of Capabilities

Machine learning or other artificial intelligence models can be trained or otherwise applied to operate as agents, interacting with websites, APIs, or other user interfaces to accomplish goals for users. For example, an agentic AI model could be prompted to order specified goods, with specified parameters, and could then interact with web forms or other aspects of a website to effect the ordering of the specified goods according to the specified parameters. Actions taken as output of the model could include logging in to an e-commerce webpage, inputting a search string into a search bar, clicking on the appropriate item from the search results (and/or clicking a ‘next page’ button until the appropriate item is presented), modifying color, size, or other parameters of the item's page, and then inputting payment and shipping information to complete the purchase.

Such a model could generate outputs that are executable to interact with a user interface, for example, to specify, relative to the HTML, the image of the rendered site, or other representation(s) of a website elements of the website to click, insert text or other inputs into, or otherwise interact with in order to accomplish the commanded goal. Such an agentic model could receive multi-model inputs, e.g., textual inputs representing HTML or other code that specifies a website or other user interface, images representing the rendering of HTML or other website code as a human user would experience it, textual or token-based inputs representing previous actions taken by the model and/or the results thereof, or other inputs. Such agentic models can include knowledge about a broad range of subjects (e.g., the model could be trained based on a broad corpus of training data, and/or could be fine-tuned or otherwise trained from a foundation model or other broadly knowledgeable model), allowing them to accomplish a wide range of tasks accurately, with minimal assistance, and via a broad range of websites, APIs, or other user interfaces.

However, such highly competent agentic AI models can be very expensive to execute. Further, such agentic AI models may be executed multiple times in order to accomplish more complex, multi-step tasks, further increasing the computational cost of their use. It would be beneficial to be able to record and analyze the behavior of such agentic models in a manner that allows their competent interactions with a user interface to be re-used later, to accomplish different tasks while significantly reducing computational cost. While the exact same requested task could be re-performed by re-executing the actions taken by the agentic AI model, it is unlikely that the exact same task would be requested in the same manner again. It is also possible to provide records of one (or more) past agentic AI model task performances as an example input to a less computationally expensive model, in order to improve the performance of the less expensive model in performing similar tasks. However, this requires the input width of the less expensive model to be wider to accommodate the input of the example prior task performance(s), cancelling some or all of the computational cost savings of using the less expensive model.

Embodiments described herein allow the actions of a competent agentic AI model to be recorded and used to generate therefrom a database of machine-executable capabilities that represent the various actions taken by the agentic AI to perform one or more past tasks. When a prompt or other command to perform another task (which may be the same as, similar to, or entirely dissimilar from the task(s) whose performance(s) were used to generate the database) is received, a subset of relevant already-generated capabilities are selected from the database and used, by a second machine learning or other AI model, to generate a machine-executable flow that can be executed to accomplish the newly-commanded task. Since the flow is generated by the second model in a machine-executable format, and the capabilities that it references/is composed of are, themselves, machine-executable, the computational cost (e.g., processor cycles, memory, storage, network interconnect bandwidth, power) to execute the flow is significantly reduced relative to, e.g., repeatedly executing a broadly competent, optionally multi-modal agentic AI model to accomplish the commanded task. Additionally, since identifying the subset of task-relevant capabilities and generating the flow therefrom are tightly-scoped and more limited analytical tasks than the broad scope of possible commanded tasks, the second model can be significantly less computationally expensive to execute (e.g., could be defined by fewer parameters, could include fewer layers, could include fewer nonlinear units) than such an agentic AI model. Thus, the methods described herein are able to achieve similar levels of accuracy as highly competent agentic AI models while exhibiting significantly reduced computational costs.

Capabilities in such a database could include a variety of functions specified, in machine-executable format (e.g., Python, C, or some other programming or scripting language), to perform various actions or other sub-task activities that were part of an agentic AI model previously performing one or more tasks. Such capabilities could be generated from records of such past task performances in a variety of ways. For example, a record, in a machine-executable format, of actions taken via one or more user interfaces to perform a previous task could be partitioned (e.g., by a large language model or other AI model) into non-overlapping subsets that correspond to respective sub-tasks of the previous task. Each non-overlapping subset can then be applied to an AI model to generate a respective capability therefor in a machine-executable format. Generating the capabilities in this way can lead to the generation of higher-quality skills at lower computational cost, e.g., relative to instructing an AI model to generate all of the capabilities in a single pass. Such a process also allows individual steps or aspects thereof (e.g., individual capabilities, individual partitions of a task recording) to be separately evaluated, preprocessed, re-generated, or otherwise analyzed, reducing the computational cost and complexity of such processes (e.g., by allowing conventional heuristic code analysis algorithms to be applied for such analyses, rather than relatively more computationally expensive machine learning models).

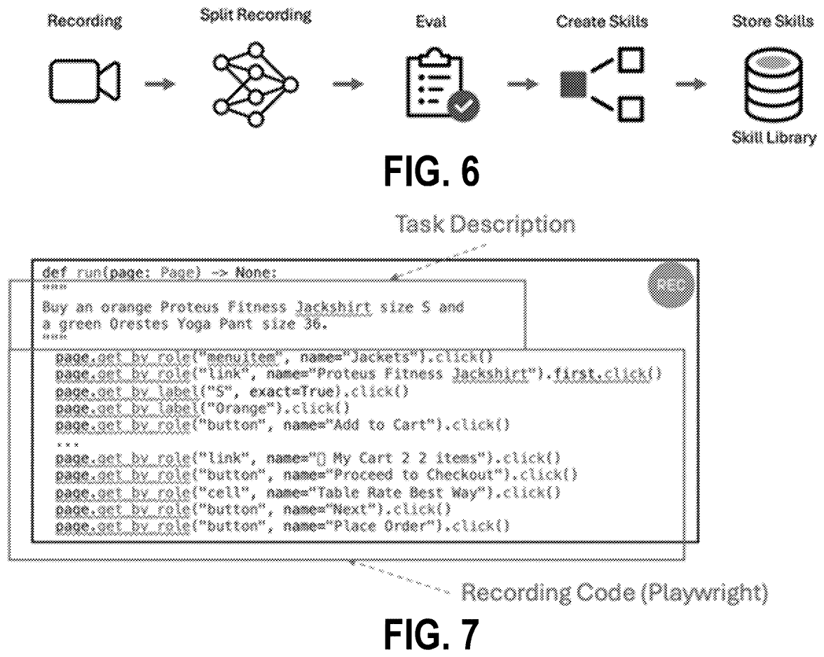

FIG. 6 depicts aspects of such a process for generating, from one or more recordings (“Recording”) of the performance of task(s) via a user interface, a plurality of capabilities (or “Skills”) in a database of capabilities (“Skill Library”). As shown, such a process can optionally include the evaluation of the generated capabilities and/or of the recording partitions used to generate them. This could include applying code analysis tools to verify that the capabilities are properly formatted or otherwise in proper form to be executed without error, to verify that the individual capabilities represent sufficiently granular tasks (e.g., by using a code complexity function to evaluate a putative capability and, if the complexity of the capability is too high, splitting the functionality of the putative capability into multiple capabilities).

FIG. 7 depicts an example of a text-based record, in a machine-executable format, of actions taken by an agentic AI model to perform a task (in the illustrated example, to purchase an “orange Proteus Fitness Jackshirt size S” and a “green Orestes Yoga Pant size 36”). As shown, such a record can represent various actions taken by the agentic AI model to achieve the commanded task. By representing the actions in a machine-executable, textual format (e.g., according to the Playwright format), the full set of actions taken by the agentic AI model can be unambiguously represented without including the relatively larger set of input data used by the agentic AI model, e.g., rendered images of web pages, full HTML representations of web pages, etc. As shown in FIG. 7, such a record can include both a record of the actions taken by the agentic AI model (“Recording Code”) as well as the command prompt given to the model to complete (“Task Description”).

Such a record can then be applied to an AI model (e.g., the same model as was used to perform the task and whose actions were recorded in the record) to identify individual capabilities representing different actions taken by the agentic AI model. This can include partitioning the text-based record into a set of non-overlapping subsets of the text-based record that correspond to the performance of respective actions of the commanded task. Each of these subsets of the record can then be used to generate a respective capability (or may, prior to that, be subjected to some analysis, e.g., complexity analysis to determine whether to further partition the subset). The partitioning and/or the conversion of a partitioned subset of a recording into a capability could be performed by the same AI model (e.g., an LLM or other large natural language model) or different AI models. In some examples, each of these tasks could be accomplished by presenting, to the ML model, a prompt that includes the recorded material to be processed (the entire record for the initial partitioning, a subset of the record for re-partitioning, or a subset of the record for conversion of the subset into a capability) as well as a command or other engineered prompt portion instructing the AI model to perform the relevant task. For example, to partition a record into smaller functions, to partition an already-partitioned subset into smaller functions, to translate a recorded subset of actions into a properly formatted function or other type of capability, or some other task(s).

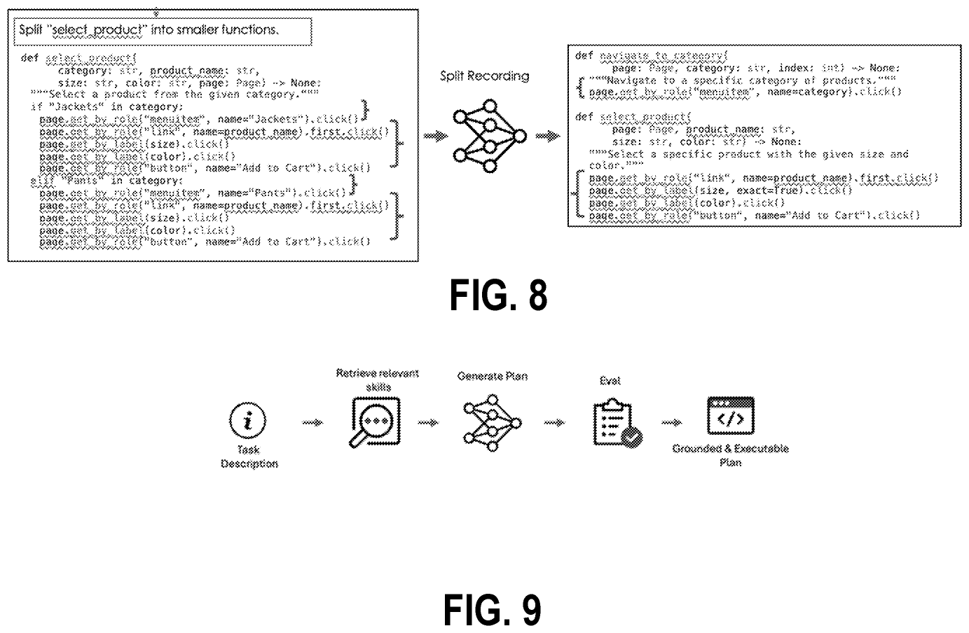

FIG. 8 depicts and example of such a process, further partitioning a subset of a record into smaller functions (e.g., due to a code complexity analysis on the subset determining that the complexity of the subset was too high). As shown, this can include providing an input capability (in the form of a function definition) along with a command to split the capability into smaller functions. As shown, the output of this could include a set of smaller functions, correctly formatted to allow their recording into a database as respective capabilities therein. Alternatively, such a process could be multi-step, first outputting respective subsets of the input function (or other record of the input overly-complex capability) and then applying each subset to an ML model to generate respective capabilities therefor.

Models used for these processes (e.g., partitioning of input records into subsets, conversion of such subsets into respective capabilities, further partitioning such subsets/capabilities into smaller, less complex subsets/capabilities) could be trained to understand the particular machine-executable language or format used in the record. For example, the AI model could be trained to receive as input and/or to generate as output machine-executable code in the Playwright user interface action representation language. In this way, the model could exhibit increased accuracy with respect to these tasks while also requiring less computational resources (e.g., processor cycles, memory, storage, network interconnect bandwidth, and/or power) than more generic models (e.g., larger LLMs or other natural language models that have been trained on a large corpus of training text to perform generic natural language tasks).

As noted above, by generating the individual capabilities in a machine-executable format, conventional code analysis techniques can be applied to evaluate the capabilities and, if necessary, modify or regenerate them. This can be done to improve their quality, ensure that they represent a sufficiently discrete set of operations/actions (e.g., a single action), ensure that they are properly formatted or otherwise executable, or improve them in some other way.

Once such a database of capabilities has been generated, it can be used to generate flows for novel tasks. As described above, this can include performing a first pass to select a subset of the available capabilities that are relevant to an input command to perform a task. The selected subset of capabilities, along with the task command, can then be applied to an AI model (e.g., a large language model trained to recognize and output code in a specified machine-executable programming language) to output a flow that is executable to perform the task by executing one or more capabilities of the selected subset. FIG. 9 depicts aspects of such a process, which may optionally include the evaluation of the generated flows. This could include applying code analysis tools to verify that the flow is properly formatted or otherwise in proper form to be executed without error, to include additional dependencies of the functions in the flow (e.g., dependencies of capabilities of the flow, functions to access input data referenced by the flow), or to perform other code analysis and processing functions.

Pre-selecting a subset of the capabilities in this way allows the flow to be generated at higher quality and at lower computational cost, e.g., relative to providing a model with a larger input width (and corresponding higher memory, cycle, network interconnect utilization, and/or power cost) with representations of all of the capabilities in the database. Additionally, the model(s) used in such a process can be significantly less computationally expensive to train and inference than the agentic AI model(s) whose recorded actions were used to generate the capabilities (e.g., such selection and/or flow-generating models can be smaller, have narrower input widths, can be text-only), since the smaller model needs only to compose a flow from a selected subset of the capabilities, rather than to be able to navigate websites, APIs, or other user interfaces itself. This allows the broader (and potentially multi-modal) knowledge and ability of the agentic AI model to be leveraged to perform tasks with significantly reduced computational costs, potentially on systems (e.g., cellphones, embedded systems) that lack sufficient memory, storage, etc. to be able to execute such agentic AI models natively.

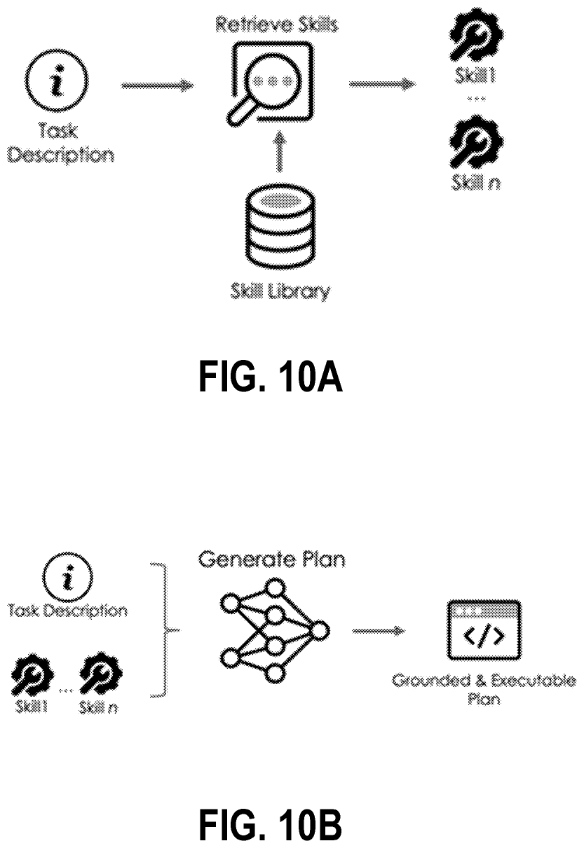

FIG. 10A depicts aspects of a process for identifying, from a database of capabilities, a subset of capabilities that are relevant to a commanded task (represented by a “Task Description.” Such a process could include determining a semantic similarity between a natural language representation of the task and the capabilities. For example, by determining a distance, cosine similarity, or other measure of similarity between a semantically-encoded embedding vector that represents the task command and semantically-encoded embedding vectors that represent each of the capabilities in the database (e.g., as part of a Retrieval-Augmented Generation search and generation process). Semantically-encoded embedding vectors that represent each of the capabilities in the database could represent the capabilities as a whole, or just textual, natural language summaries of their functionality (e.g., that were generated by an AI model during capability generation from respective subsets of records of past task performances).

Once a subset of relevant capabilities have been identified, representations thereof, along with a representation of the commanded task, can be applied to an AI model to generate a flow (“Grounded & Executable Plan” in FIG. 10B). The flow includes execution of one or more of the identified capabilities to accomplish the commanded task. Aspects of such a flow generation process are depicted in FIG. 10B. The set of capabilities presented to the model could be limited to the identified relevant capabilities, or could be expanded. For example, the database of capabilities could include a representation of dependencies between the different capabilities in the database (e.g., a representation of a graph of such dependencies). In such examples, the set of capabilities input to the AI model could include both the identified relevant capabilities as well as some or all of the capabilities on which the identified relevant capabilities depend.

The generation of machine-executable flows from capabilities in this manner also allows re-generation of all or part of the flows and/or the capabilities in response to failure of the flow to execute and/or the determination, by code analysis algorithms, that the flow will fail to execute or is deficient in some other manner. For example, a deficient flow, along with a representation of its deficiency (e.g., the output of a code analysis algorithm, an error message thrown during attempted execution of the flow) can be applied to an AI model (e.g., the same AI model used to generate the flow, or a different model) to generate an updated, corrected flow.

Additionally or alternatively, it could be determined that specific one(s) of the capabilities have become deficient (e.g., due to changes in aspects of a website, API, or other user interface implicated by the capabilities). These deficient capabilities could then be selectively updated. Distilling machine-executable records of past task performances into a database of capabilities as described herein reduces the computational cost incurred when one (or more) of the capabilities is rendered inoperable. For example, if an API, website, or other interface used by one of the capabilities changes (e.g., due to an update to a web interface), then the next execution of that capability will likely fail. This failed execution can be detected and used to trigger the update (e.g., by the action of an agentic AI model) of only the failed capability. This leads to a reduced computational cost compared to, e.g., updating a larger task prototype that might represent many different actions.

Additionally, the failed capability can be used to tightly specify the scope of the updated capability. This can increase the quality of the updated capability and also reduce the computational cost of generating the updated capability. This reduction can be achieved since an agentic AI model used to generate the updated capability (by attempting to perform the user interface actions underlying the capability) can focus only on the one (or few) actions necessary to accomplish the specific sub-task that is the target of the failed capability, rather than a wider range and number of actions. The cost to generate the updated capability from the record of such agentic AI actions can also be reduced, since the scope of the capability to be generated can be circumscribed based on the original, failed capability. For example, by providing the AI model with the original, failed capability and instructing it to generate a corrected capability based on a record of the agentic AI model's actions to accomplish the functionality of the failed capability.

Additionally or alternatively, a human technician can be prompted to update such a failed capability manually. In some examples, actions taken by a human, rather than agentic AI model or other variety of AI model, via one or more user interfaces to perform a task can be recorded in a machine-executable format and used to generate one or more capabilities of a capability database as described herein.

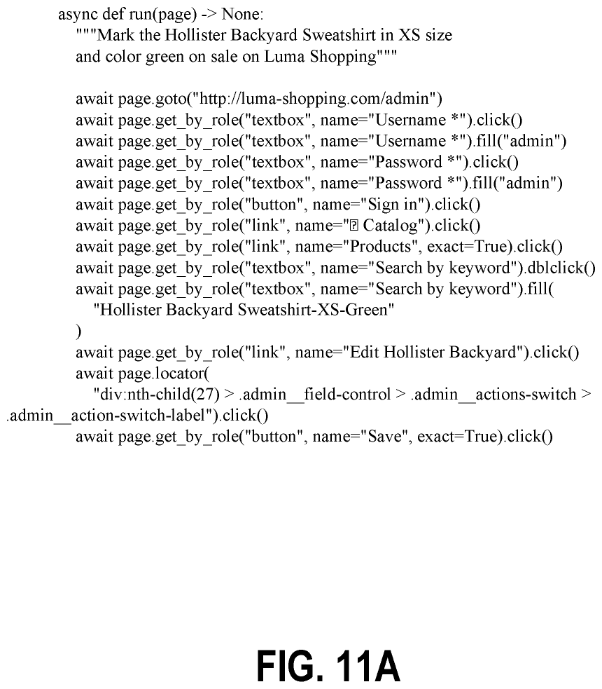

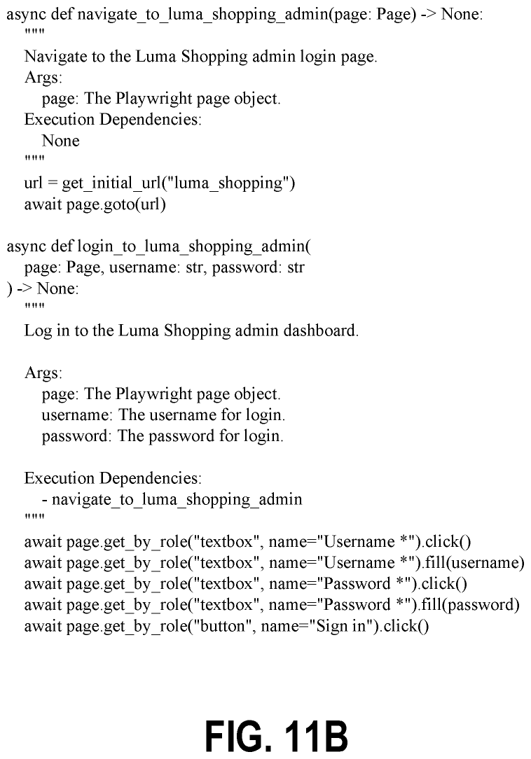

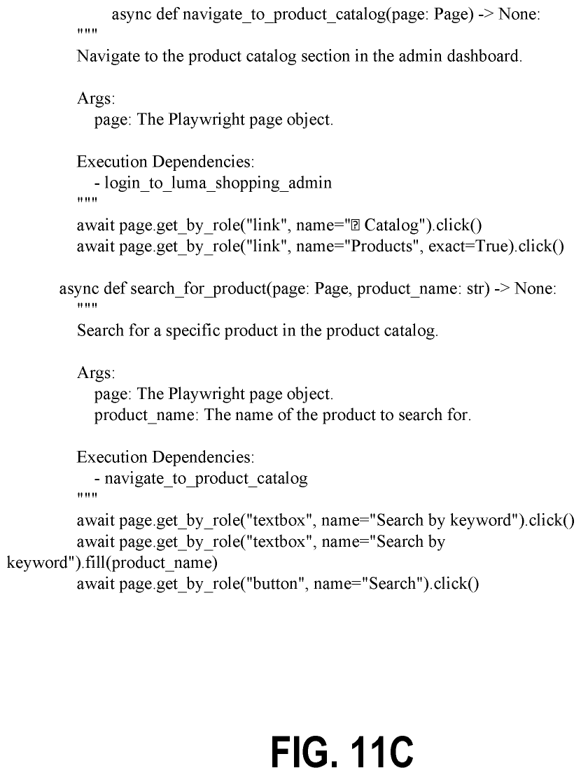

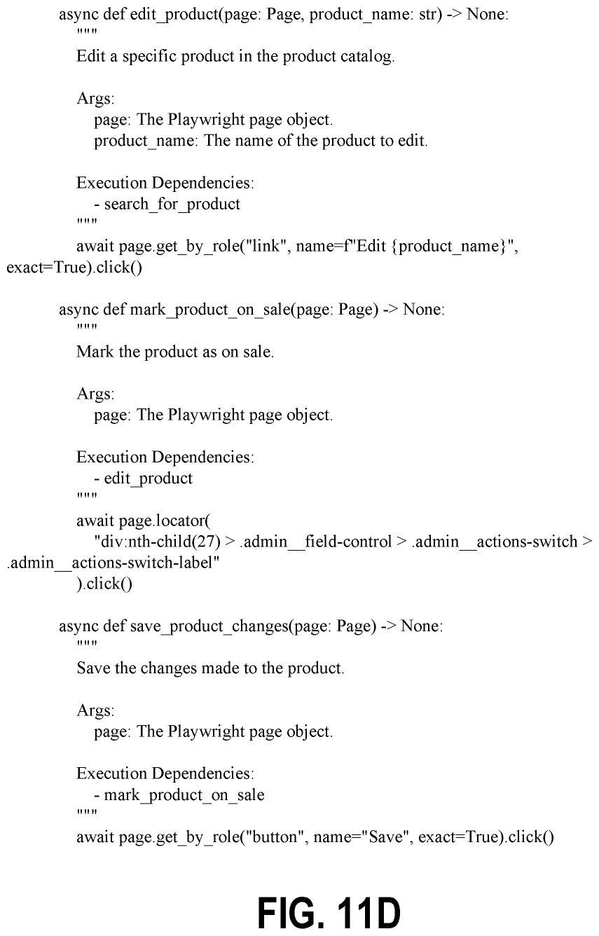

As an example of the embodiments described herein, an example of a text-based record in a machine-executable format (the “Playwright” language) of actions taken by an AI agent via a user interface to “Mark the Hollister Backyard Sweatshirt in XS size and color green on sale on Luma Shopping” is provided in FIG. 11A.

As an example of the embodiments described herein, examples of capabilities generated from the above record are provided in FIGS. 11B-D.

The embodiments described herein can be performed via a variety of systems configured in a variety of ways. For example, all or part of the methods described herein could be implemented as a virtual machine (“VM”), and interaction with user interfaces, APIs, or other action(s) to execute a workflow and/or a capability or action thereof could include the VM engaging with the APIs (e.g., by sending packets over a real or simulated network connection, by engaging with an API implemented by a service, program, or other software element running on the VM), user interfaces (e.g., by generating simulated clicks or other user interface inputs), or other elements to execute the workflows, capabilities, and/or tasks. In some examples, some or all of the methods described herein could be implemented in a browser (e.g., a browser of a user's computer). This could provide a number of benefits. For example, a browser being used by a user may have (or have access to) a user's credentials and/or may have initiated one or more authenticated sessions (e.g., via HTTPS or some other secure session protocol) using the user's credentials and/or using input(s) of the user (e.g., the user having previously initiated the authenticated session through the browser, optionally using a cellphone or other accessory system to begin the authenticated session). In such examples, the browser generating and then executing a workflow according to the methods described herein could, by virtue of already having access to the user's credential(s) and/or having initiated the authenticated session, take one or more actions using the credential and/or authenticated session. This could have the benefit of improving security by, e.g., not transmitting credentials or other information necessary to initiate an authenticated session to a VM or other system. The browser executing the workflow and/or elements thereof could include the VM sending and receiving information from remote systems (e.g., via a secure channel), e.g., to allow the computation needed to inference one or more machine learning models (e.g., one or more LLMs) to be provided by the remote system(s). Additionally or alternatively, inferencing such machine learning models or other computational processes could be performed locally on the same machine (e.g., laptop) that is providing the browser.

### IX. Example Multi-Agent Networks

A variety of tasks can be accomplished by using a machine learning model, configured to act as an autonomous or semi-autonomous ‘agent,’ to perform the tasks. For example, a textual prompt that describes the task to be performed, and optionally additional information (e.g., a description of past performances of similar tasks, a description of an interpreter or other computing environment in which the task is to be performed), can be provided as an input to the machine learning agent, and the agent's output(s) applied to an interpreter or otherwise used to accomplish the task. In some examples, the performance of the task could be improved by using a set of two or more machine learning models (e.g., multiple agent-type models) in combination to perform the task. This could allow the task to be performed better (e.g., at higher accuracy, conforming to specified constraints more fully, more likely to perform the task correctly across multiple performances) and/or to reduce the computational cost (e.g., with respect to processor cycles, memory use, storage needed for model parameters, network interconnect bandwidth, power) to perform the task at a set quality. For example, the multiple different agents could be fine-tuned to perform different aspects of a task. Additionally or alternatively, such multiple agents could differ with respect to the types of inputs presented thereto and/or outputs generated thereby to perform different aspects of a task (e.g., the same underlying model, e.g., an LLM, could be operated to accomplish different aspects of a task by modifying the prompts or other inputs applied thereto).

For example, a first agent (e.g., a ‘planner’ model) could act to generate a flow or other type of plan to accomplish a task and then a second agent (e.g., an ‘executor’ model) could receive the flow (e.g., as a set of tokens, textual input, or other representation) and execute it in order to accomplish the target task. The planner could receive as input a textual string or other representation of the target task (e.g., objectives to be fulfilled, constraints to satisfy, user-specific information) and could also have access to a database of capabilities to inform the generation of a flow (e.g., comprised of a selected subset of capabilities from the database) to accomplish the task. Additionally or alternatively, the first agent could have access to a database of flows and could, in response to an input, output a relevant flow from the database in order to accomplish a commanded task (e.g., in examples wherein the commanded task, or a historical task sufficiently similar thereto, has already been requested an a flow generated therefor). The second agent could receive the flow (e.g., as a series of tokens or other input representing the selected capabilities thereof, dependencies therebetween, and task-specific information) and then execute the flow in order to accomplish the commanded task. This can include the second agent evaluating the results of actions taken to perform the flow (e.g., to perform specific constituent capabilities thereof) and, where those results indicate an insufficient level of task or sub-task success or some other level of failure, re-performing actions (e.g., in a manner different than a first attempt, informed by the results of the first attempt, in order to correct whatever insufficiency resulted in failure on the first attempt).

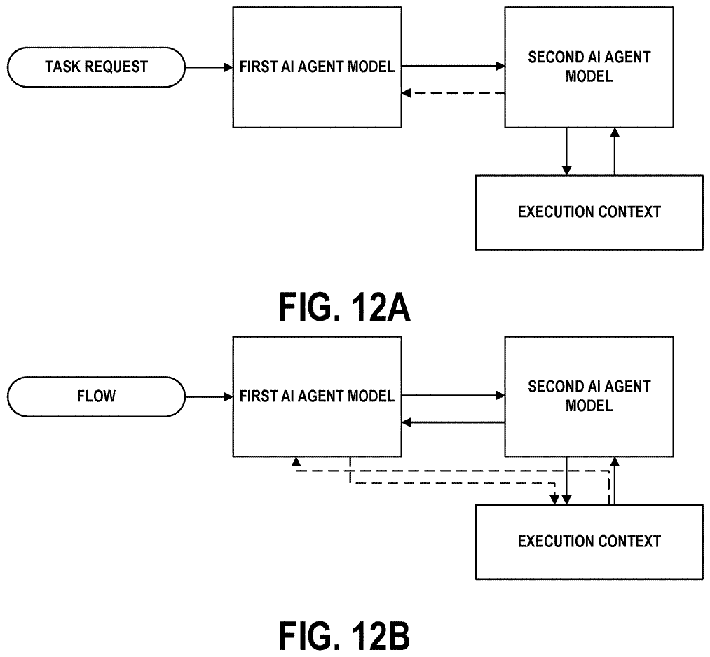

FIG. 12A illustrates aspects of an example implementation of such a system. A natural language request to perform a task (“TASK REQUEST”), which may be received from a user or generated in some other manner (e.g., by a user clicking a button or providing some other input associated with the natural language request to perform the task), is applied to a first AI agent. The first AI agent then generates a flow that represents how to perform the requested task. For example, the flow could include or otherwise indicate a plurality of capabilities, and optionally dependencies therebetween or other information about ordering, to perform to complete the task. The flow could include example performances of the task, user information (e.g., credentials), context information, the identity or configuration of one or more action environments (e.g., APIs, command interpreters, GUIs) used to perform the task and/or capabilities or other sub-tasks thereof, or other information related to performance of the requested task. The first AI agent could generate such a flow by reference to one or more databases of capabilities, previously generated and/or used flows, knowledgebase information, or other information sources.

A representation of the flow (e.g., as text, as a sequence of tokens that represent text or other information) is then presented as an input to a second AI agent, which performs each action or other task (e.g., of a plurality of capabilities indicated therein) using one or more APIs, command lines or other interpreters, communications protocols, GUIs, or other action interfaces (“EXECUTION CONTEXT”).

As shown, the second AI agent performing the tasks can include bidirectional information flow with the action interface(s) (e.g., commands transmitted from the agent to a command line, and the results of the execution of such commands transmitted back to the agent). Additionally, while the first agent sends the flow or other information to the second agent, the second agent can also send information back to the first agent, e.g., records of the performance of a flow that the first agent can use for various applications. For example, the first agent could, based on such records, update one or more capabilities, flows, or other stored tasks or sub-tasks in one or more databases (e.g., databases previously used to identify relevant flows and/or capabilities used to generate the flow sent to the second AI agent). In some examples, the first AI agent could generate new capabilities, flows, or other task-related artifacts based on such recordings or other information received from the second AI agent and/or related to the second AI agent interacting with the action interface(s).

Regardless of the source of the flow or other plan for executing a task (e.g., a stored flow retrieved from a database, a flow manually specified by a user and/or selected from a set of available flows by a user, a flow generated from a set or subset of available capabilities by an AI agent), an ‘executor’ agent can implement such a flow in a variety of ways. For example, the executor agent could operate to instruct a subordinate agent (e.g., a ‘polyglot’ agent) to perform actions (e.g., to perform individual capabilities of a flow) and also to evaluate the subordinate agent's performance thereof. The executor agent could, based on such an evaluation, instruct the subordinate agent to perform a next action (e.g., a next capability in the flow) if the performance of the prior action was successful or, if the performance of the prior action was a failure or otherwise unsatisfactory, could instruct the subordinate model agent to attempt the failed action again. This could include providing to the subordinate agent a record of the actions previously taken thereby and/or results of such actions in order to inform an improved, successful performance of the commanded action(s). This can allow the execution of the flow to be accomplished at higher quality (e.g., accuracy, likelihood of overall success) and/or at lower computational cost (e.g., with respect to processor cycles, memory use, storage needed for model parameters, network interconnect bandwidth, power) at a specified level of quality.

FIG. 12B illustrates aspects of an example implementation of such a system. A flow or other representation of the steps of a task (“FLOW”), which may be composed of a set or subset of available capabilities in a database by a planner AI agent or generated in some other manner, is applied to a first AI agent. The first AI agent then generates outputs instructing a second AI agent to perform individual steps, capabilities, or other actions or aspects of the flow. For example, the flow could indicated a plurality of capabilities, and the first AI agent could provide, in turn, representations of each of the plurality of capabilities in turn, optionally with relevant context information (e.g., user credentials or other information about the user provided by the flow, a history of commands, outputs, or other context or state information about a GUI, interpreter, API, or other action interface(s) to be used to perform the capability).

The flow could include or otherwise indicate dependencies between the capabilities, in which case the first AI agent could instruct the second AI agent to perform the capabilities according to the dependencies (e.g., such that a given capability is only attempted after other capabilit (ies) that provide inputs therefor and/or that accomplish precedent tasks therefor have been successfully completed). Where multiple capabilities can be performed without depending upon each other, the first AI agent could cause those multiple capabilities to be performed at least partially overlapping in time or in an otherwise parallel manner (e.g., by sending prompts or other instructions to multiple different second AI agents and/or to multiple instantiations of the same model). Such task scheduling could be accomplished by the operation of an LLM or other machine learning model generating instructions, order of execution plans, etc. Additionally or alternatively, a heuristic algorithm or other glue logic could be included as part of the first AI agent to accomplish such parallel execution (e.g., based on a directed acyclic graph or other representation of dependencies between capabilities and/or steps of a flow).

The output of the first AI agent is then presented as an input to the second AI agent, which performs the instructed capability or other sub-task using one or more APIs, command lines or other interpreters, communications protocols, GUIs, or other action interfaces (“EXECUTION CONTEXT”). This can include multiple rounds of the second agent generating outputs (e.g., code or other machine-executable textual outputs to an API, command line interface, interpreter, or other machine-language interface, words or other textual outputs to text fields of a GUI, locations and click types of mouse clicks, menu interactions, or other interactions with a GUI) to the action interface(s) and receiving resulting responses therefrom (e.g., textual outputs from an API, command line interface, interpreter, or other machine-language interface, textual representations in HTML or some other language of a change in a GUI, rendered image(s) of a GUI).

Once the second AI agent has completed the instructed task, the results of the task are sent back to the first AI agent for evaluation. This can include presenting the first model with a terminal output of the second model, with a terminal output or state of the action interface, with all or a portion of a record of all of the actions (e.g., inputs and outputs) generated/received by the second model during its performance of the commanded capability or other task, or some other information about the second AI agent's activities or their result. The first AI agent can then evaluate whether the commanded capability was successfully performed. If the second model completed the commanded capability successfully, the first AI agent could move on to the next capability in the flow (or, if that was the final capability, could provide a final output or other result to the planner AI agent or other flow-providing system(s)). If the second model failed to complete the commanded capability successfully, the first AI agent could provide the second AI agent (or an alternative AI agent) with an alternative prompt or other input, in order to result in successful performance of the commanded capability. This can include providing additional context information (e.g., appending to the prompt a record of the second model's previous attempt(s) at the capability, along with an indication that those attempt(s) failed and optionally how those attempt(s) failed), re-phrasing aspects of the prompt, or otherwise modifying or replacing the prompt used to command the second AI agent.

The embodiments described herein (e.g., in relation to FIGS. 12A and/or 12B) could provide improvements to the operation of machine learning models or other AI agent systems by, e.g., fine-tuning the two agents for their respective different tasks (e.g., training the first agent to perform higher-level management of the execution of a flow, relying on a subordinate model for the actual action generation and interface feedback ingestion, a task for which the subordinate model has been specifically trained). Additionally or alternatively, the manner of use of the two agents (e.g., the prompts or other inputs applied thereto) may be different. In some examples, the subordinate model could be a multi-modal model, configured to ingest both textual information from an API, user interface, or other action-performance context (e.g., as HTML, interpreter outputs, or other textual information from one or more action interfaces) and also visual information (e.g., images of rendered webpages) from that interface. In such examples, partitioning the flow-execution task between the executor and subordinate agents can reduce overall computational cost by allowing the executor to focus on strategic tasks (e.g., memory, planning, evaluation) while the subordinate model is able to focus on performance of more short-term tasks (e.g., the performance of individual capabilities of the flow at a time), optionally in a multi-modal manner. Such specialization of the two agents could be accomplished by, e.g., allowing more of the executor model's input width to be occupied by information about the overall flow and the history and other state information about the in-process execution of the flow (e.g., representations of prior failed and/or successful performances of capabilities of the flow), while more of the subordinate model's width is occupied by tokens representing visual or other rich multi-modal information representing the current state (e.g., rendered images) of a user interface, API, or other action-performance context.

In some examples, capabilities or other representations of common tasks or actions could be stored in a database or other record in the form of machine-executable code. Providing an agent with a representation of such a capability could include providing the machine-executable code of the capability to the model as part of the input prompt, whereupon the agent could generate output(s) to an interpreter or other action interface that directly conform to lines or other segments of the machine-executable code or that vary from it (e.g., as a result of the agent ‘knowing’ that some aspect of the code should be modified due to changes in the interface, feedback or other state information previously received from the action interface, or some other consideration). In some examples, some or all such capabilities could also include a flag or other stored metadata that is indicative of whether the machine-executable code of the capability is likely to be executable as-is (e.g., by simply applying each line of code of the capability, in turn, to an interpreter or other action interface), and if executed as-is, whether it is likely that such execution will result in successful achievement of the objective of the capability. Such a flag may be referred to as a ‘deterministic’ flag, and capabilities that are marked with such a flag (e.g., by including a corresponding key/value pair, by having a corresponding bit, byte, value, or other element set to ‘l’ or otherwise set to a value indicating that the capability is likely successfully executable as-is) may be referred to as ‘deterministic.’

To reduce the computational cost of executing flows, capabilities of a flow that are marked as ‘deterministic’ may be applied directly to an action interface (e.g., applied, line by line, to the input of an interpreter, applied line by line into an API, or transmitted line by line via HTML to a remote server), rather than being implemented by an agent, thereby avoiding the significant computational costs (e.g., with respect to processor cycles, memory use, storage needed for model parameters, network interconnect bandwidth, power) of inferencing a machine learning model. This is indicated in FIG. 12B by the dashed lines connecting the first AI agent with the action interface, indicating that the machine-executable code of a capability in the flow is being directly sent to the action interface without ‘interpretation’ by the second AI agent, and that the results of such direct execution are similarly passed directly back to the first AI agent, in order to evaluate whether the direct execution of the machine-executable code resulted in success.

Such deterministic flags for capabilities could be generated and/or updated in a variety of ways. For example, a machine learning model used to generate such capabilities may, as part of that generation, also generate the flag as an estimate of whether the machine-executable code of the capability is likely to be successfully executable as-is. After a failed execution of a capability with a set flag, the flag could be un-set to reflect that the capability, when executed as-is, resulted in failure; such failed execution could be detected by the activity of an executor agent (e.g., the first AI agent of FIG. 12B and/or the second AI agent of FIG. 12A) or some other supervisory agent. After one or more successful as-is executions, by an agent, of the machine-executable code of a capability, the flag could be set to reflect that the capability can likely be successfully executed as-is, avoiding the computational cost of the agent for future executions of the capability.

Note that, as described herein, an “AI agent” could include elements in addition to one or more LLMs, generative machine learning models, or other types of agent trained to classify inputs, generate textual or other outputs, and/or to perform some other tasks. For example, an AI agent as described herein could include a trained LLM along with glue logic used to, e.g., extract one or more machine-executable code snippets, mouse commands, or other outputs from the textual or other type of output(s) of the LLM and to apply the extracted outputs to one or more GUIs, APIs, command line interfaces, or other action contexts. Such glue logic could also be used to detect the results of such outputs and to apply the results, along with additional information (e.g., the output used to cause the results, prompt information, history of prior inputs/outputs or other context information) as input to the LLM to perform the next action of the LLM (e.g., taking the next step of a subordinate model to accomplish a commanded capability or other task, evaluating the output of a subordinate model and providing thereto a next capability to perform, evaluating a record of an executor model's performance of a flow to update a database of capabilities and/or flows). In another example, an executor-type AI agent could include glue logic to schedule the performance of capabilities (e.g., by sending the capabilities as raw inputs to a subordinate model, or by passing such information, along with context or other information, to a machine learning model to generate command outputs for the subordinate model) and, where applicable, to determine whether a given capability is “likely to result in success” and, if so, to apply machine-executable code thereof to an interpreter or other action interface without the use of a subordinate AI agent. Such glue logic could also be used to evaluate associated machine-executable code to, e.g., evaluate whether such execution resulted in successful performance of the capability. If not, a machine learning model (e.g., an LLM) of the executor AI agent could be inferenced based on the result of the attempted task performance to, e.g., generate a command to a subordinate model in order to perform the attempted task. Glue logic can also function to route outputs to the correct action interfaces (e.g., to the correct API, to a GUI), to record inputs/outputs from action interfaces, and/or provide some other functionality.

Additionally, note that various models being described herein as “first” and “second” or otherwise different may include using respective different LLMs, transformers, multi-model models, and/or other machine learning models that have been trained such that their parameters and/or architectures differ. Additionally or alternatively, such “different” AI agents could include the same or similar parameters, architectures, etc. and could differ instead with respect to their inputs and/or outputs, e.g., with respect to the prompts applied thereto. For example, an executor AI agent could be characterized by a prompt that includes a representation of a flow and instructions to “perform the flow by generating instructions for a subordinate model to perform each capability of the flow in turn, evaluating the results each time and instructing the subordinate model to re-perform failed capabilities,” while the subordinate AI agent thereof could be characterized by receiving prompts output from the executor model.

A planner AI agent as described herein could be configured in a variety of ways to generate flows or other task completion plans (e.g., composed from sets of capabilities). Such a planner AI agent could additionally or alternatively be configured to perform other actions (e.g., to analyze recordings of past tasks completions by an executor AI agent or user and generate therefrom capabilities, flows, or other artifacts for later re-use, to curate a database of such capabilities and/or flows based on success or failure in their use).

As noted above, such a planner AI agent could include non-model glue logic or other components to, e.g., identify existing capabilities and/or flows from databases of capabilities and/or flows for use by the planner AI agent and/or by other agents of a system as described herein. For example, a semantic-based search (using, e.g., machine learning models trained to generate semantically representative embedding vectors for input capabilities, flows, natural language task requests or context information) or other type of search could be performed on the input request to identify relevant flows and/or capabilities. In some examples, if a sufficiently similar or otherwise relevant flow is identified, it could be selected and used as-is (e.g., passed as input to an executor model without modification, except possibly to add user or request specific context information thereto) without inferencing an LLM or other machine learning model. Alternatively, such an LLM or other machine learning model could be used to evaluate the selected flow(s) to confirm their relevance to the request, to modify the selected flow(s), and/or to use the selected flow(s) as input in generating a novel flow for the requested task.

In some examples, the search (e.g., model-generated embedding-based semantic search) could be used to identify, from a database of capabilities, a subset of capabilities that are relevant to the task request. Representations of the identified subset of capabilities could then be provided as input to an LLM or other generative model of the planner AI agent to inform the planner model in generating a flow. This could allow a less computationally expensive generative model (e.g., a model with a shorter maximum input width) to be used to generate flows, as only the most relevant capabilities are provided as instructive input (rather than, e.g., all of the capabilities in a database).

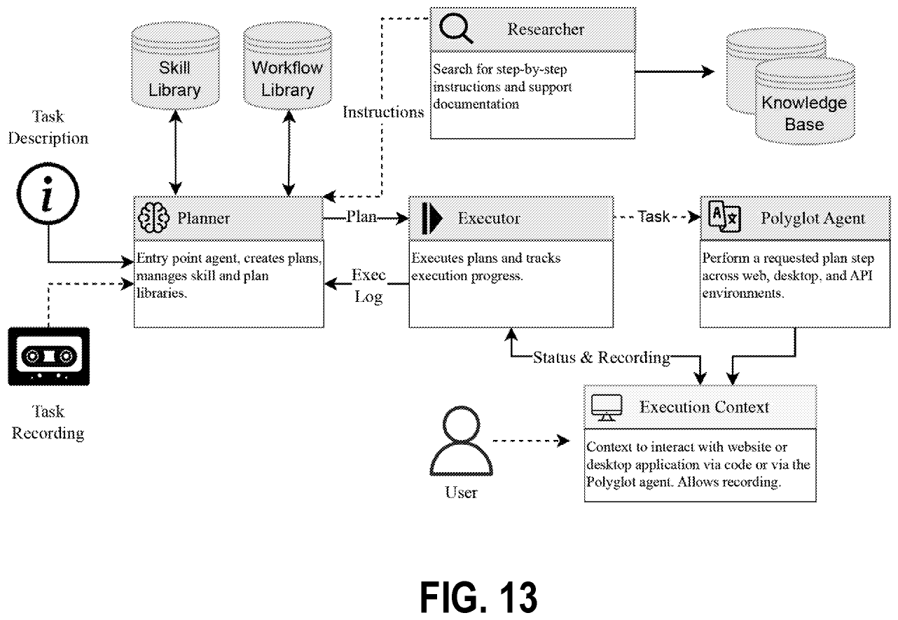

As noted above, the embodiments described herein could be implemented in a variety of different ways. For example, FIG. 13 depicts aspects of an example system, which may be referred to herein as “GASTA” (for “Generalized Agent for Scalable Task Automation”). FIG. 13 provides an overview of GASTA's architecture. GASTA is a hybrid agent framework that integrates a polyglot planning architecture, providing seamless coordination across web browsers, local applications, APIs, and system tools. This design allows GASTA to adaptively execute tasks in heterogeneous digital environments, addressing the limitations of prior agents. GASTA advances hybrid reasoning by introducing a polyglot planning architecture capable of dynamically orchestrating interactions across diverse modalities. This allows the agents thereof to fluidly coordinate actions over web browsers, local applications, APIs, and system tools as needed by the task. Furthermore, GASTA can integrate real-time knowledge retrieval, environment-aware execution, and decision monitoring to provide adaptability and coherence in long-horizon tasks.

By unifying cross-platform planning with robust execution, GASTA can provide a scalable foundation for practical, real-world automation. GASTA includes at least four collaborating agents: Planner, Executor, Polyglot Agent, and Researcher. Each agent accomplishes a specific role in the performance of a requested task. These agents can interact through dynamically managed knowledge resources, including a Capability Library (“Skill Library”), a Flow Library (“Workflow Library”), external knowledge bases, and a shared Execution Context, as illustrated in FIG. 13.

The Planner AI agent can generate multi-step polyglot execution plans or other types of flows from task descriptions. It can also augment system knowledge by extracting reusable capabilities and workflows from, e.g., recordings of task performances by human users and/or prior execution logs of GASTA.

The Executor AI agent executes flows generated (e.g., selected from those available within the Flow Library) by the Planner. It can manage task progression, monitor execution, log outcomes, and manage the execution context.

The Polyglot Agent AI agent can executes plan steps, as delegated by the Executor, within the shared Execution Context. This can involve direct interaction with diverse operational environments (e.g., web, desktop, APIs).

The optional Researcher Agent can support the Planner by finding and synthesizing instructions from external knowledge bases (e.g., documentation). These instructions can be used by the Planner to formulate more accurate plans when available. The Researcher agent can operate based on instructions from the Planner (e.g., requests for potentially relevant instructions, context information, etc.) and/or may operate asynchronously to, e.g., generate new capabilities and/or flows based on solutions found in a knowledgebase or other information source.

The GASTA framework can use several distinct knowledge sources, which may be dynamically updated and used by the agents (e.g., by the Planner generating new capabilities/flows, modifying existing capabilities/flows, and/or deleting obsolete, defective, or otherwise deprecated capabilities/flows).

Skill Library: The Skill Library is a centralized repository for atomic actions or other capabilities performable by the system, which may be embodied as well-defined, machine-executable code functions. Capabilities can include web interactions (e.g., Playwright, Selenium scripts) and desktop automations (e.g., Python RPA scripts). They can also include API calls and functions for LLM-based information extraction (e.g., from web content). Each capability can include a natural language description, defined parameters, and/or notes offering context or guidance for its execution. Additionally, each capability can be associated with metadata to facilitate its proper execution by the Executor agent. A capability can be designated as non-deterministic if its execution or outcome may vary due to dynamic content or some other circumstance leading to a decreased likelihood that execution as-is will result in successful task completion. In such instances, the capability's code can serve as a reference for the Polyglot Agent rather than being directly executed. A capability definition can also include references to prerequisite capabilities to be completed prior to its own execution. Such explicit dependency information can allow the Planner agent to construct a directed acyclic graph (DAG) or other representation of the overall task's workflow. Such a DAG or other dependency structure can allow the Executor to run independent capabilities in parallel, improving efficiency for suitable tasks.

Workflow Library: The Workflow Library serves as a repository for reusable flows. A flow represents a plan template, which consists of sequences of steps or capabilities that have been successfully employed to accomplish specific tasks previously. Each template flow can include a natural language description, aggregated parameters from its constituent capabilities, and an ordered sequence of steps (each of which may be or include a reference to one of the constituent capabilities, each of which may correspond to more than one step). This sequence can be linear or if its constituent capabilities allow parallelism, it can form a DAG. A flow step can reference an existing capabilities or be a natural language description. The latter can be provided for novel tasks and can be interpreted by the Polyglot Agent. When generating a plan for a new task, the Planner agent can initially query the workflow library for a relevant template flow to enhance efficiency. The Planner can add new flows by abstracting successful task executions or processing task recordings. Furthermore, to maintain workflow relevance and reliability, GASTA can implement a failure handling mechanism. If a task plan using an existing flow fails, the Planner can remove the faulty template flow from the Workflow Library. This process can keep the library current and containing only validated, reusable flows. This self-updating mechanism can be beneficial in in dynamic environments where applications evolve, providing continued library relevance.

External Knowledge Bases: External knowledge bases are resources the Researcher Agent can use to find and synthesize task-relevant instructions. These include technical documentation, support forums, and relevant prior logs from external systems.

GASTA can operate in two primary modes: Learning from demonstrations and Performing a task.

Learning from Demonstrations: In this mode, the system receives a Task Description (e.g., a natural language request to perform such a task) and an associated Task Recording. The Planner Agent analyzes the recording to extract reusable capabilities and create a flow stored in the Workflow Library. This enables learning from demonstrations. It is useful for tasks with custom applications that may lack documentation. This can also be beneficial for individualized tasks where detailed descriptions are challenging to create.

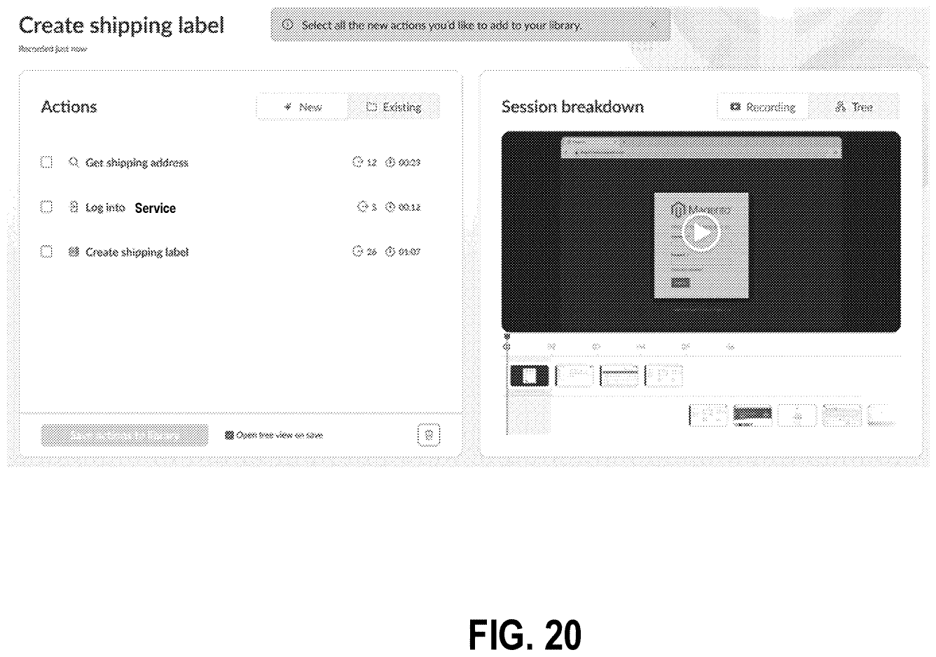

It can be beneficial to provide a user with a display related to such a process of extracting capabilities from task recordings. This can be done to provide the users with a quick, accurate understanding of how the raw recordings are translated into reusable capabilities. Such a display can also have the benefit of transforming the translation process, from the perspective of the user, from an opaque, fully automated process into an interactive, understandable process. Such a display can employ some of the aspects of video editing workflows. In such an example, a user could visualize the task recording along a timeline, seeing how distinct tasks and actions are segmented and how those segments are extracted and converted into structured capabilities and/or flows. In such an example, the user could use the user interface to scrub through the timeline, isolating specific moments, removing irrelevant sections, refining boundaries between tasks, or making other modifications prior to finalization of the capability generation process. Such an approach can provide the user with direct control over what the system learns and how that knowledge is represented. By making the extraction process visible and editable, the platform increases transparency, reduces ambiguity around what the AI has inferred, and empowers users to correct mistakes early. Over time, this can build confidence that the resulting capabilities accurately reflect real workflows, leading to greater trust, higher-quality reuse, and a stronger sense of human-AI collaboration. An example of such a user interface is depicted in FIG. 20.

Performing a Task: This mode is initiated when the system receives a Task Description and unfolds in three primary phases:

Plan Generation: The Planner Agent starts by consulting the Workflow Library to identify a suitable, pre-existing plan template. If an appropriate template is not found, the Planner synthesizes a new plan. For new plans, the Planner can request instructions from the Researcher Agent. When such instructions are available, the Planner can integrate them and draw upon relevant capabilities from the Skill Library. If initial instructions for novel tasks are unavailable, the plan may be high-level (e.g., only the task description). In such scenarios, concrete steps (e.g., new capabilities) may be derived later from the Polyglot Agent's recorded actions. The Planner can be prompted or otherwise configured to prioritize structured capabilities and established flows. The Researcher's instructions can guide capability selection and sequencing or define steps for new capabilities. These undefined steps are typically routed to the Polyglot Agent. The resulting plan is an ordered sequence of steps, each a capability reference or a natural language action.

Plan Execution: The Executor first establishes an Execution Context for the received plan. It executes sequential workflows step-by-step. For DAG workflows, can manage parallel execution of independent branches where feasible. The Executor can create a detailed Execution Log recording each step's execution. The Executor can directly run deterministic capabilities within the Execution Context (e.g., by sending lines of code from the relevant capability, without modification, to the input of an interpreter, API, or other machine-language interface). It can delegate steps to the Polyglot Agent if a capability fails, is missing, or is non-deterministic (e.g., a capability that has a ‘non-deterministic’ flag). Delegation can also occur for steps defined by natural language descriptions (e.g., for high-level goals in novel tasks). When delegating, the Executor can provide the Polyglot Agent with contextual information. This can include the overall plan, task description, execution history, current step details, and/or access to the shared Execution Context. The Polyglot Agent can then interact with the operational environment (e.g., web, desktop, API). All interactions, by any agent, utilize the shared Execution Context, which maintains necessary state (e.g., browser state, logging states). The Executor can record the Polyglot Agent's actions for subsequent capability extraction. After plan completion, the execution log can be passed to the Planner. The Planner can then inform the user of the task's status and/or initiate the log analysis phase.

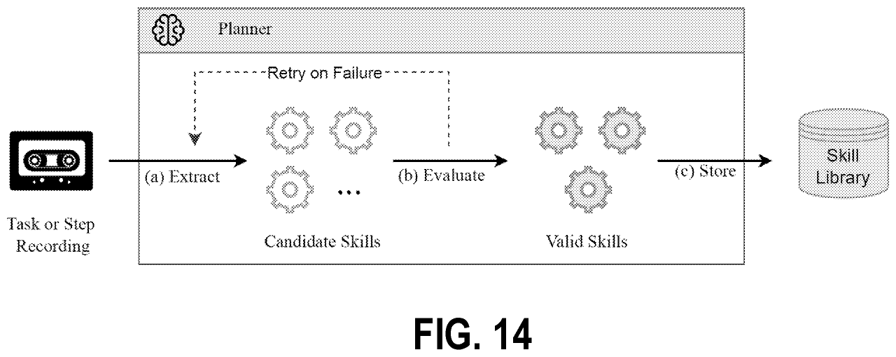

GASTA can enhance its operational capabilities by learning and expanding its Skill Library through the automated processing of task and step recordings. These recordings can take the form of code segments. They can originate from system execution logs (e.g., capturing Polyglot Agent actions) and/or user provided demonstrations (e.g., Python Playwright scripts). GASTA can transforms these recordings into modular, reusable functions called capabilities. This transformation can be achieved using a Large Language Model (LLM) or other generative machine learning model prompted or otherwise configured to refactor these code snippets into modular and reusable code snippets. Aspects of such a process are depicted in FIG. 14.

Capability Extraction. The Planner agent can employ an LLM to perform capability extraction. It can provide the LLM with structured information and instructions to guide this process. For extraction from recordings, the Planner can instruct the LLM to analyze the raw code segment and refactor it into a reusable function. This process can include generating a descriptive function name, a comprehensive natural language description of its purpose, expected inputs, outputs, and/or any execution prerequisites. The LLM can also identify and generalize parameters, aiming to avoid hardcoded values. To further aid this process, the Planner agent can provide the LLM with a list of potentially relevant existing capabilities from the Skill Library. These can be retrieved via semantic search based on the task description or by including all available capabilities if the context window permits. This dual-purpose approach can help to generate new capabilities and facilitate capability composition, where the LLM can create new capabilities that leverage existing ones. The Planner can direct the LLM to ensure that any extracted or composed capability strictly adheres to the original recording's functionality or the specified compositional goal. The system can provide contextual information, such as the overall task description, to aid the LLM in understanding the segment's purpose.

Capability Evaluation Pipeline. The GASTA Skill Library can take the form of a valid code library, allowing the use of software engineering best practices for validation. Extracted or composed capabilities may not be immediately integrated into the library. Instead, they may undergo a rigorous, automated Capability Evaluation Pipeline to verify their quality, correctness, and reusability. This comprehensive multi-stage pipeline can validate capabilities through static code analysis, documentation adequacy checks, parameter generalization verification (e.g., using Abstract Syntax Tree (AST) analysis to identify hardcoded values), functional equivalence testing against original recordings (e.g., using mock environments and derived test cases), cyclomatic complexity control, redundancy prevention (e.g., via semantic similarity of descriptions), with iterative LLM-driven refinement or other corrective process(es) used to improve capabilities that initially fail validation. Each stage can employ specific techniques and criteria to assess different facets of the capability, ensuring only robust and reliable capabilities are incorporated into the library. Pipeline scalability can be addressed via optimized test case selection, efficient vector search (e.g., Approximate Nearest Neighbor (ANN) for large libraries), parallelization, and sampling of large recording sets. This systematic methodology for capability extraction and comprehensive evaluation ensures that the GASTA Skill Library evolves as a curated repository of high-quality, reusable, and well-documented functional components, facilitating the system's scalable automation capabilities.

After task completion, the Planner can receive the execution log and initiate a background analysis. This analysis can refine the system's knowledge and improve future performance. The specific actions taken can depend on the task's outcome. If task execution failed, and the failure is attributable to a previously reliable workflow template (e.g., due to external application changes), the Planner can remove the faulty template from the Workflow Library. If a capability previously considered deterministic exhibited unexpected behavior leading to failure, the system can re-evaluate it. This re-evaluation may result in the capability being marked as non-deterministic in the Skill Library, leading future invocations to be handled by the Polyglot Agent. If task execution was successful, particularly when the Polyglot Agent was involved (e.g., for novel tasks), the Planner can process the recordings of the Polyglot Agent's actions from the execution log. It can then extract new, reusable capabilities from these recordings and add them to the Skill Library. Subsequently, the Planner can create a new workflow template based on the successful execution path, incorporating any newly extracted capabilities, and add this template to the Workflow Library. This process can continuously expand GASTA's repertoire of automated solutions.

### X. Experimental Results

The embodiments described herein were experimentally evaluated across two settings to assess the capabilities of: (1) extracting reusable capabilities and workflows from a single demonstration and generalizing to unseen variants of the same task, and (2) performing complex, multi-step tasks given only a natural language description, without prior demonstrations. All experiments were conducted using a subset of the WebArena benchmark, restricted to tasks from the GitLab and One-Stop-Shop (AdminShop) environments. These two domains offer rich, interface-driven workflows that reflect realistic automation scenarios-such as repository management, order processing, and permission configuration-making them suitable for studying task scalability and multi-agent coordination. The evaluation described herein measures success rate, efficiency, and library usage, and includes both ablations and comparisons against baseline agents and scripted automation, thereby quantifying the benefits of the modular architecture and capability-learning pipeline of the embodiments described herein.

Unless stated otherwise, all agents in the experimentally validated system(s) were implemented using GPT-4.1 with a 1M-token context window. A retrieval system was not used for retrieving capabilities or workflows; instead, the prompt was optimized to include only function signatures and natural language documentation (omitting code) for capabilities, and only workflow descriptions and parameter definitions for workflows which fit in the available context. The Researcher agent was implemented as a web agent and was provided with direct links to official documentation sites, along with site-specific instructions on how to perform effective search (e.g., query structure, navigation rules). These documentation sources are aligned with those specified in the WebArena benchmark. All executions occurred within an isolated virtual machine running a Chromium browser, and demonstration recordings were created using asynchronous Python Playwright scripts.

The Web Arena paradigm was used, focusing on a subset of tasks from the GitLab and One-StopShop (AdminShop) environments, selected for their realistic and procedural nature. These two domains provide structured, multi-step workflows that users might plausibly request from a human support agent, such as managing repositories, configuring permissions, and processing online orders. For each intent template t, one seed instance was randomly sampled and a Playwright demonstration of the task was manually recorded. This demonstration was used as input to the capability extraction pipeline. The remaining instances of t constituted the evaluation set; all other templates were excluded from the experiment to prevent cross-template leakage. This procedure yielded 241 seed-task recordings and 571 held-out tasks. Agents were evaluated in BrowserGym under controlled conditions (fixed random seed, 5-minute wall-clock timeout), and each experiment configuration was run three times. Task success was determined using WebArena's automated checkers.

Each recorded Playwright script (40-120 lines of code) was processed by the Planner agent, which invoked a Large Language Model to refactor the code into a set of atomic, parameterized capabilities. When multiple reusable fragments were identified, a parent workflow was also generated. The resulting capability candidates were passed through an automated evaluation pipeline as described herein. The regeneration loop was capped at n=3 attempts; capabilities failing all attempts were discarded. Only candidates that passed all stages were added to the system's Skill and Workflow Libraries. To isolate the performance impact of learning from demonstrations, the Researcher agent was disabled in this experiment; no external knowledge sources were used.

To evaluate the contribution of extracted capabilities, comparison was made against the following baselines:
1) GASTAskills: the full system as described herein, using all extracted capabilities and workflows during evaluation.
2) GASTAno-skills: the same system as above, but the Skill and Workflow Libraries were emptied before evaluation—only built-in capabilities remained. This isolated the benefit of learning from demonstrations.
3) Script-replay: The original Playwright demonstration was parameterized and re-executed on all matching held-out tasks. This approximated the upper bound of hand-coded script reuse, assuming strong generalization.

System performance was evaluated across the following dimensions:
1) Task success rate (%): Percentage of held-out tasks completed successfully, reported per site and macro-averaged.
2) Efficiency: Median wall-clock execution time and average plan length (in steps), measuring both speed and compactness.
3) Library usage: Fraction of steps resolved by reusable capabilities from the Skill Library vs. routed to the Polyglot Agent.
4) Extraction quality: Pass rate of capability candidates through the evaluation pipeline, total number of validated capabilities added, and proportion of redundant candidates pruned via semantic similarity.

With respect to task success, GASTAskills achieved a macro-averaged success rate of 78.2%, outperforming GASTAno-skills by +19.4 percentage points (statistically significant at p<0.01). Gains were most pronounced on GitLab and One-Stop-Shop, where workflows were highly reusable.

With respect to efficiency, median task time dropped by 41.7% and plan length decreased by 25%, reflecting better plan reuse and more direct execution paths.

With respect to capability extraction quality, 87.1% of generated capability candidates passed the full evaluation pipeline. AST-based generalization checks flagged hardcoded CSS selectors in the remaining 12.9%. Redundancy pruning eliminated 18% of near-duplicate candidates.

With respect to self-replay accuracy, GASTA-skills-replay matched Script-replay on 96.3% of seed tasks, confirming high functional fidelity of extracted workflows.

These results confirm that the embodiments described herein can extract high-quality reusable components from minimal supervision and leverage them for scalable, template-consistent task execution. Notably, ablations that omitted functional equivalence testing led to +23% larger libraries but decreased success by 4.7%, highlighting the benefit of filtering for long-term reliability.

TABLE 2
provides a performance comparison with respect to
WebArena tasks from GitLab and AdminShop sites.

| Method | SR(%) | Admin(%) | GitLab(%) |
|---|---|---|---|
| Vanilla GPT | 12.7 | 10.4 | 15.0 |
| GASTA_{no-fallback} | 36.3 | 32.4 | 40.3 |
| GASTA_{no-researcher} | 32.65 | 37.2 | 28.1 |
| GASTA | 50.5 | 49.8 | 51.3 |

SR = overall success rate (%).

### XI. Example Operations

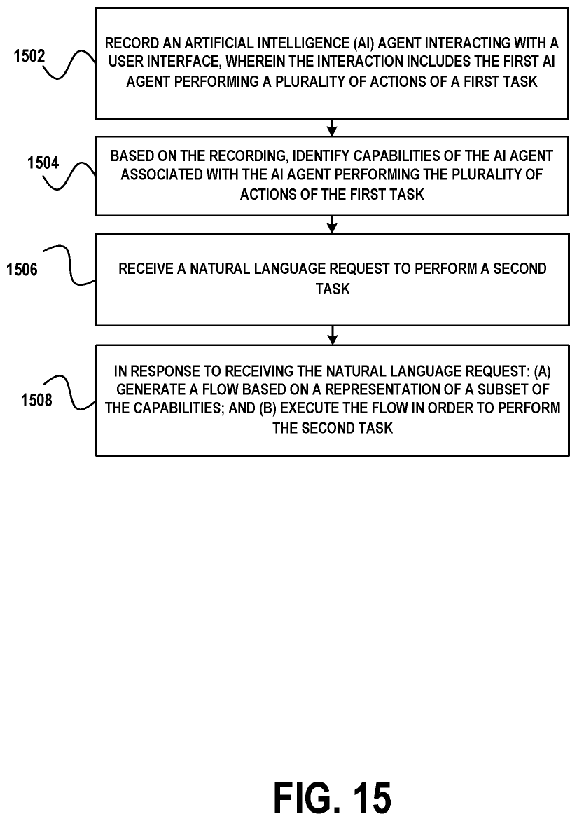

FIG. 15 is a flow chart illustrating an example embodiment. The process illustrated by FIG. 15 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 15 may be simplified by the removal of any one or more of the features shown therein. Further, these embodiments may be combined with features, aspects, and/or implementations of any of the previous figures or otherwise described herein.

The embodiments of FIG. 15 provide a technical solution to a technical problem. One technical problem being solved is automatic navigation of websites, APIs, and other user interfaces to satisfy natural language user requests. In practice, this is problematic because such requests, and the user interfaces used to implement them, can be very complex, implicating a broad ability to reason about the world in general and such user interfaces in particular. In some examples, it may be necessary to provide both textual and visual representations of such interfaces in order for an agentic AI model (in such examples, a multi-modal model, to receive visual and textual information) to be able to accurately navigate the user interface and accomplish the commanded task. Accordingly, agentic AI models capable of accomplishing such tasks may be computationally expensive to execute (e.g., with respect to processor cycles, memory footprint, storage needed to maintain model parameters, network interconnect bandwidth to transfer intermediate results between processors, power), and may require execution multiple times in order to accomplish complex tasks (e.g., to provide the model with feedback regarding the performance of sub-tasks).

Another technical problem being solved by the embodiments of FIG. 15 is converting the performance of tasks by such expensive, broadly competent models into reusable capabilities that can be used by significantly less computationally expensive models (e.g., smaller, text-only natural language models with relatively narrow input widths that can be executed using much less processor cycles, memory, storage, network interconnect bandwidth, power, and/or other computational costs) to competently perform subsequent tasks. In practice, this is problematic because it is difficult to translate the performance of a task by a highly competent and broadly trained model into a representation thereof that can be efficiently ingested or otherwise applied by a less competent model or otherwise less expensive algorithm to improve the competence of the lesser model at performing subsequent tasks. For example, one (or more) past performances of a task by a highly competent model could be recorded and that record then applied in whole as a supplemental, instructive input to a lesser model. However, this requires the lesser model to have a much wider input length, increasing the processor cycles, memory, network interconnect bandwidth, power, or other computational costs of executing the lesser model. Additionally, it can be difficult for such a model to correctly ‘understand’ the essential actions of the past performance and apply that generic understanding to the performance of subsequent tasks.

The embodiments of FIG. 15 can distill recordings of past task performance(s) into sets of machine-executable capabilities. These capabilities can then be efficiently selected and composited into flows for the performance of subsequent tasks. By separating the actions taken during the past task performance(s) into separate capabilities, it becomes easier to select, from the set of available capabilities, a subset of most relevant capabilities to a subsequent task. Then, representations of only the relevant capabilities are applied to a model, along with a command for the subsequent task, in order to generate a flow therefrom. Accordingly, the flow-generating model can be much less computationally expensive to execute (e.g., than a highly competent agentic AI model capable of performing generic tasks with unknown user interfaces without the benefit of a database of such capabilities). Additionally, since the set of relevant capabilities is a subset of the available capabilities, the flow-generating model can also have a shorter input length, leading to additional savings with respect to computational cost.

Moreover, the two-stage method included in the embodiments of FIG. 15 for generating capabilities from recordings of task performances provides a reduction with respect to computational cost. By separating the capability generation task into a first recording-partitioning task followed by individual capability-generation tasks based on each partition, less computationally expensive AI model(s) can be used for the tasks, for a given level of competence and/or accuracy.

Further, by partitioning such recordings into simple actions, conventional code-analysis tools can be applied to filter, process, validate, or otherwise analyze the capabilities. Such code analysis tools (e.g., code complexity algorithms) can be implemented via heuristic algorithms, rather than by relatively more computationally expensive machine learning model-based analysis.

Partitioning the actions of recorded past task performances into individual capabilities that are later assembled into flows can also provide computational cost savings when the capabilities fail, e.g., due to changes in the corresponding aspects of a user interface with which the capabilities interact. During execution of a flow, the failure of attempted execution of a particular capability thereof allows computational resources used to correct the failed capability (e.g., the processor cycles, memory, network interconnect bandwidth, power, and/or other computational costs attendant to the execution of a broadly competent multi-modal agentic AI model to attempt to perform a commanded task or sub-task) to be reduced by attempting to perform only the action defined by the failed capability, rather than the entire commanded task (with potentially many individual actions, and corresponding model executions, required to do so).

The embodiments of FIG. 15 include, at block 1502, recording an artificial intelligence (AI) agent interacting with a user interface, wherein the interaction includes the AI agent performing a plurality of actions of a first task. In some examples, recording the interaction between the AI agent and the user interface includes: (i) applying a natural language representation of the first task to the AI agent to generate one or more model outputs; (ii) based on the model outputs, performing a plurality of actions via the user interface; and (iii) recording, in a machine-executable format, representations of the plurality of actions in a text-based record. In such examples, the AI agent could be a multi-modal agent, and the embodiments of FIG. 15 could further includes, responsive to performing the plurality of actions via the user interface: (i) receiving, via the user interface, a representation of the user interface that includes graphical and textual elements; (ii) applying, to the multi-modal agent, the a representation of the graphical and textual elements to generate one or more additional model outputs; (iii) based on the additional model outputs, performing an additional plurality of actions via the user interface; and (iv) recording, in the machine-executable format, representations of the additional plurality of actions in the text-based record.

In some examples, the first task is associated with an application, and the user interface is provided by the application.

In some examples, the user interface includes a graphical web interface and an API for at least one of a cloud computing environment or a database.

The embodiments of FIG. 15 include, at block 1504, based on the recording, identifying capabilities of the AI agent associated with the AI agent performing the plurality of actions of the first task.

The embodiments of FIG. 15 include, at block 1506, receiving a natural language request to perform a second task. In some examples, the first task and the second task are the same task.

The embodiments of FIG. 15 include, at block 1508, in response to receiving the natural language request: (a) generating (e.g., by an AI model) a flow based on a representation of a subset of the capabilities; and (b) executing the flow in order to perform the second task. In some examples, executing the flow includes performing at least one capability of the subset of capabilities to take at least one action of the plurality of actions of the first task via the user interface.

In some examples, the embodiments of FIG. 15 further include recording, in a database of capabilities, the capabilities of the AI agent associated with the AI agent performing the plurality of actions of the first task, and generating the flow includes: (i) identifying the subset of the capabilities from the database of capabilities based on similarities between the natural language request and capabilities of a database of capabilities; and (ii) applying a representation of the subset of the capabilities to the AI model to generate the flow. For example, the database of capabilities could also include a record of dependencies between capabilities in the database of capabilities, and applying a representation of the subset of the capabilities to the AI model to generate the flow could include applying, to the AI model, a representation of (i) the subset of the capabilities and (ii) at least one capability that, according to the record of dependencies, is depended upon by at least one capability of the subset to generate the flow.

In some examples, recording the interaction between the AI agent and the user interface includes recording a text-based record in a machine-executable format of actions taken by the AI via the user interface, and identifying capabilities of the AI agent associated with the AI agent performing the plurality of actions of the first task includes: (i) partitioning the text-based record into a plurality of non-overlapping subsets of the text-based record that correspond to the performance of respective actions of the first task; and (ii) applying the non-overlapping subset of the text-based record that corresponds to the performance of a particular action of the plurality of actions to an AI model to generate a corresponding capability of the identified capabilities of the AI agent. In such examples, the embodiments of FIG. 15 could further include: (i) performing a code complexity analysis on the generated corresponding capability to determine that the generated corresponding capability is more complex than a threshold complexity value; and (ii) responsively: (a) partitioning the non-overlapping subset of the text-based record that corresponds to the performance of the particular action into two or more subsets, and (b) for each of the two or more subsets, generating a respective capability of the identified capabilities of the AI agent.

In some examples, the embodiments of FIG. 15 further include, prior to receiving the natural language request to perform the second task: (i) receiving a natural language request to perform a third task; and (ii) in response to receiving the natural language request: (a) generating, by the AI model, a second flow based on a representation of a second subset of the capabilities; and (b) attempting to execute the second flow in order to perform the third task, wherein attempting to execute the second flow comprises: (1) attempting to perform a first capability of the second subset of the capabilities to take an action via the user interface; (2) responsive to determining that the attempt to perform the first capability failed, applying a representation of the first capability to the AI agent to generate one or more model outputs; (3) based on the model outputs, performing at least one action via the user interface; and (4) based on the at least one action performed via the user interface, updating the first capability in a database of capabilities.

In some examples, receiving the natural language request to perform the second task is performed by a web browser and the embodiments of FIG. 15 further include, by the web browser, obtaining a credential or beginning an authenticated session with a remote service, wherein executing the flow in order to perform the second task comprises using the credential to perform at least one capability of the subset of capabilities or performing at least one capability of the subset of capabilities via the authenticated session.

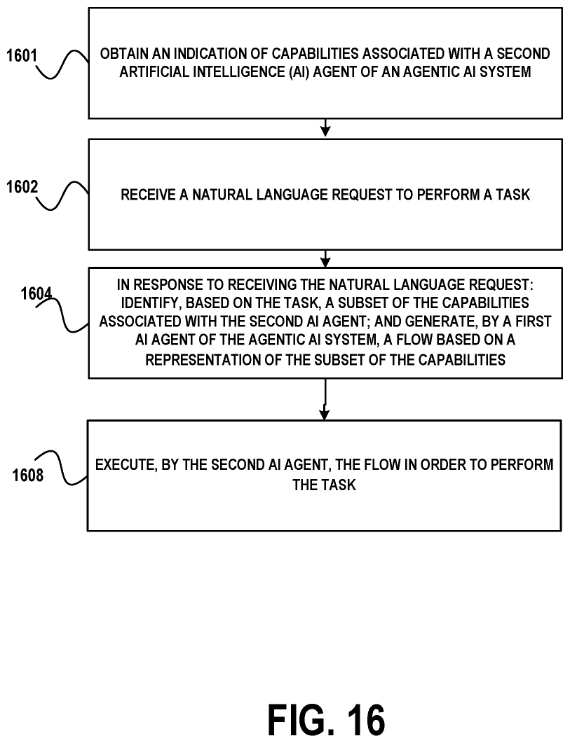

FIG. 16 is a flow chart illustrating an example embodiment. The process illustrated by FIG. 16 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 16 may be simplified by the removal of any one or more of the features shown therein. Further, these embodiments may be combined with features, aspects, and/or implementations of any of the previous figures or otherwise described herein.

The embodiments of FIG. 16 include, at block 1601, obtaining an indication of capabilities associated with a second artificial intelligence (AI) agent of an agentic AI system.

The embodiments of FIG. 16 include, at block 1602, receiving a natural language request to perform a task.

The embodiments of FIG. 16 include, at block 1604, in response to receiving the natural language request: identifying, based on the task, a subset of the capabilities associated with the second AI agent; and generating, by a first AI agent of the agentic AI system, a flow based on a representation of the subset of the capabilities.

The embodiments of FIG. 16 include, at block 1608, executing, by the second AI agent, the flow in order to perform the task.

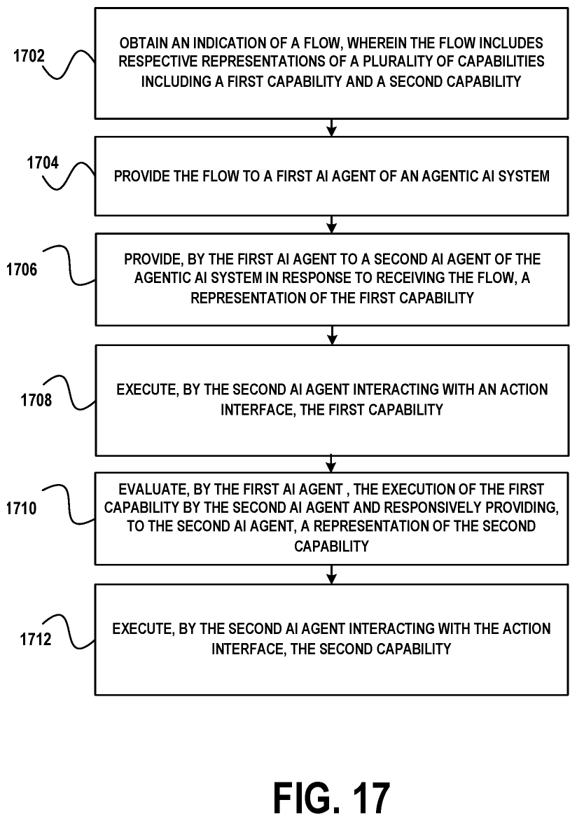

FIG. 17 is a flow chart illustrating an example embodiment. The process illustrated by FIG. 17 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 17 may be simplified by the removal of any one or more of the features shown therein. Further, these embodiments may be combined with features, aspects, and/or implementations of any of the previous figures or otherwise described herein.

The embodiments of FIG. 17 include, at block 1702, obtaining an indication of a flow, wherein the flow includes respective representations of a plurality of capabilities including a first capability and a second capability.

The embodiments of FIG. 17 include, at block 1704, providing the flow to a first AI agent of an agentic AI system.

The embodiments of FIG. 17 include, at block 1706, providing, by the first AI agent to a second AI agent of the agentic AI system in response to receiving the flow, a representation of the first capability.

The embodiments of FIG. 17 include, at block 1708, executing, by the second AI agent interacting with an action interface, the first capability.

The embodiments of FIG. 17 include, at block 1710, evaluating, by the first AI agent, the execution of the first capability by the second AI agent and responsively providing, to the second AI agent, a representation of the second capability.

The embodiments of FIG. 17 include, at block 1712, executing, by the second AI agent interacting with the action interface, the second capability.

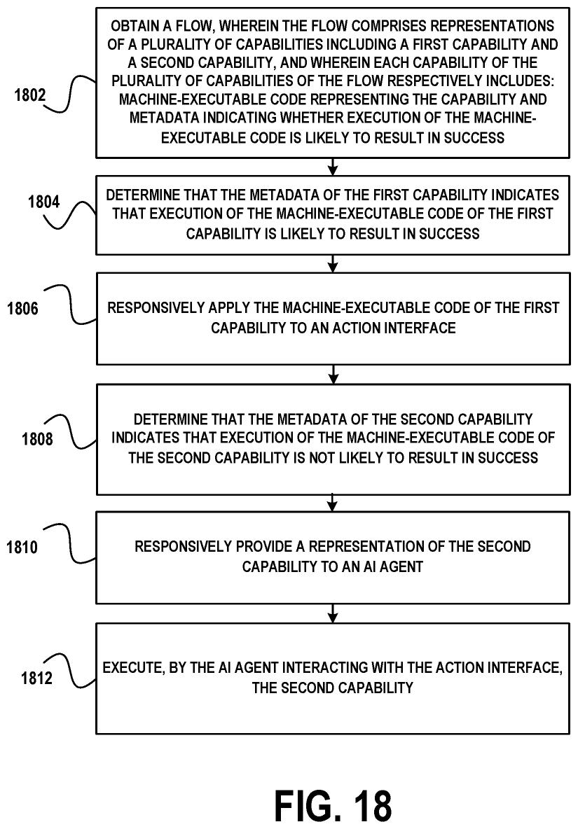

FIG. 18 is a flow chart illustrating an example embodiment. The process illustrated by FIG. 18 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 18 may be simplified by the removal of any one or more of the features shown therein. Further, these embodiments may be combined with features, aspects, and/or implementations of any of the previous figures or otherwise described herein.

The embodiments of FIG. 18 include, at block 1802, obtaining a flow, wherein the flow comprises representations of a plurality of capabilities including a first capability and a second capability, and wherein each capability of the plurality of capabilities of the flow respectively includes: machine-executable code representing the capability and metadata indicating whether execution of the machine-executable code is likely to result in success.

The embodiments of FIG. 18 include, at block 1804, determining that the metadata of the first capability indicates that execution of the machine-executable code of the first capability is likely to result in success.

The embodiments of FIG. 18 include, at block 1806, responsively applying the machine-executable code of the first capability to an action interface.

The embodiments of FIG. 18 include, at block 1808, determining that the metadata of the second capability indicates that execution of the machine-executable code of the second capability is not likely to result in success.

The embodiments of FIG. 18 include, at block 1810, responsively providing a representation of the second capability to an AI agent.

The embodiments of FIG. 18 include, at block 1812, executing, by the AI agent interacting with the action interface, the second capability.

The embodiments of FIGS. 16-18 provide technical solutions for a variety of technical problems. For example, improving the performance of complex, multi-step tasks (e.g., flows composed of multiple capabilities, optionally representing dependencies therebetween by graphs or other representations) by dividing aspects of that performance across multiple agents, which may be or include AI agents. By dividing such complex tasks across multiple different AI agents (e.g., across a planner model and an executor model, and/or across an executor model and a multi-model sub-task performance model), the models can be improved (e.g., by additional training, by modifying model architecture to receive multiple modes of input and/or generate multiple modes of output) and/or the prompts applied to the model can be improved. This can be done to improve the various models' performance with respect to the different aspects of the overall task performance. For example, to improve the use of a first AI agent to generate flows or other task plans; to improve the use of a second AI agent for executing such flows (which can include the evaluation of attempted execution of capabilities or other sub-tasks thereof); and/or to improve the use of a third AI agent to performing sub-tasks within complex GUIs or other multi-modal action environments which may behave less deterministically.

Additionally, using a first AI agent to evaluate the performance of individual sub-tasks by a second AI agent can lead to significant savings with respect to processor cycles, memory use, network interconnect bandwidth use, storage use, power, or other computational costs. This is because the second model's failure to perform specific sub-tasks can be detected and re-attempted without incurring the time and computational cost of re-attempting the entire task. Further, the first model can optionally modify the prompt applied to the second model that lead to the failure (e.g., by the first model generating additional instructions or context based on the failure and/or by appending information about the failed attempt to the prompt), reducing the likelihood that the second model fails to perform the sub-task again.

The use of such an executor AI agent or other type of agent to coordinate and evaluate the performance of individual capabilities or other sub-tasks of a flow or other complex task can also provide technical benefits with respect to the time taken and parallelize-ability of such tasks. This is because such an executor agent can coordinate the performance of multiple sub-tasks at the same time (e.g., such that the performance of multiple different capabilities or other sub-tasks of a flow at least partially overlap in time). The performance of such multiple capabilities in parallel could be done based on a graph or other representation of dependencies therebetween present in a flow or other representation of a task, e.g., where two or more different sub-tasks are not indicated as being dependent upon each other, the two or more different sub-tasks may be performed in parallel. This can reduce the amount of time needed to perform a flow and/or to adapt the time taken to the available computational resources.

Yet further, providing capabilities in a database/in a flow with labels or other metadata indicating whether execution of machine-executable code thereof is likely to result in success can provide savings with respect to time and/or computational costs needed to execute such capabilities. This is because, where such a label or other metadata is available, capabilities that are “likely to result in success” when the machine-executable code thereof is executed (e.g., natively in an API, command line or other machine code-interpreting interface, HTTP connection, or other action environment), such execution can be attempted without incurring the expense of, e.g., inferencing an LLM, multi-modal model, or other expensive AI agent. Where such attempts are unsuccessful, the capability can then be applied (e.g., as part of a prompt) to such an AI agent to attempt to perform the capability again, now with the benefit of the AI agent's competence and ability to adapt to changes in the action interface. Even if a non-zero number of attempts to execute the machine-executable code of “likely to result in success” capabilities end in failure, significant time and computational cost savings will be obtained relative using an AI agent by default.

### XII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
recording an artificial intelligence (AI) agent interacting with a user interface, wherein the interaction includes the AI agent performing a plurality of actions of a first task;
based on the recording, identifying capabilities of the AI agent associated with the AI agent performing the plurality of actions of the first task;
receiving a natural language request to perform a second task; and
in response to receiving the request:
generating a flow based on a representation of a subset of the capabilities; and
executing the flow in order to perform the second task.

2. The method of claim 1, wherein the first task is associated with an application, and wherein the user interface is provided by the application.

3. The method of claim 1, wherein executing the flow includes performing at least one capability of the subset of capabilities to take at least one action of the plurality of actions of the first task via the user interface.

4. The method of claim 1, wherein generating the flow comprises:
identifying the subset of the capabilities of the AI agent based on similarities between the natural language request and capabilities of a database of capabilities; and
applying a representation of the subset of the capabilities to an AI model to generate the flow.

5. The method of claim 4, wherein the capabilities of the AI agent are stored in a non-transitory memory that also includes a record of dependencies between capabilities in the non-transitory memory, and wherein applying a representation of the subset of the capabilities to the AI model to generate the flow comprises applying, to the AI model, a representation of (i) the subset of the capabilities and (ii) at least one capability that, according to the record of dependencies, is depended upon by at least one capability of the subset to generate the flow.

6. The method of claim 1, wherein the first task and the second task are the same task.

7. The method of claim 1, wherein recording the interaction between the AI agent and the user interface comprises recording a text-based record in a machine-executable format of actions taken by the AI agent via the user interface, and wherein identifying capabilities of the AI agent associated with the AI agent performing the plurality of actions of the first task comprises:
partitioning the text-based record into a plurality of non-overlapping subsets of the text-based record that correspond to the performance of respective actions of the first task; and
applying the non-overlapping subset of the text-based record that corresponds to the performance of a particular action of the plurality of actions to an AI model to generate a corresponding capability of the identified capabilities of the AI agent.

8. The method of claim 7, further comprising:
performing a code complexity analysis on the generated corresponding capability to determine that the generated corresponding capability is more complex than a threshold complexity value; and
responsively: (i) partitioning the non-overlapping subset of the text-based record that corresponds to the performance of the particular action into two or more subsets, and (ii) for each of the two or more subsets, generating a respective capability of the identified capabilities of the AI agent.

9. The method of claim 1, wherein recording the interaction between the AI agent and the user interface comprises:
applying a natural language representation of the first task to the AI agent to generate one or more model outputs;
based on the model outputs, performing a plurality of actions via the user interface; and
recording, in a machine-executable format, representations of the plurality of actions in a text-based record.

10. The method of claim 9, wherein the AI agent is a multi-modal agent, and wherein the method further comprises, responsive to performing the plurality of actions via the user interface:
receiving, via the user interface, a representation of the user interface that includes graphical and textual elements;
applying, to the multi-modal agent, the a representation of the graphical and textual elements to generate one or more additional model outputs;
based on the additional model outputs, performing an additional plurality of actions via the user interface; and
recording, in the machine-executable format, representations of the additional plurality of actions in the text-based record.

11. The method of claim 1, further comprising, prior to receiving the natural language request to perform the second task:
receiving a natural language request to perform a third task; and
in response to receiving the natural language request:
generating, by the AI model, a second flow based on a representation of a second subset of the capabilities; and
attempting to execute the second flow in order to perform the third task, wherein attempting to execute the second flow comprises:
attempting to perform a first capability of the second subset of the capabilities to take an action via the user interface;
responsive to determining that the attempt to perform the first capability failed, applying a representation of the first capability to the AI agent to generate one or more model outputs;
based on the model outputs, performing at least one action via the user interface; and
based on the at least one action performed via the user interface, updating the first capability in a non-transitory memory of stored capabilities.

12. The method of claim 1, wherein the user interface comprises a graphical web interface and an API for at least one of a cloud computing environment or a database.

13. The method of claim 1, wherein receiving the natural language request to perform the second task is performed by a web browser, wherein the method further comprises:
by the web browser, obtaining a credential or beginning an authenticated session with a remote service, wherein executing the flow in order to perform the second task comprises using the credential to perform at least one capability of the subset of capabilities or performing at least one capability of the subset of capabilities via the authenticated session.

14. A non-transitory computer-readable medium, having stored thereon program instructions that, upon execution by a computing system, cause the computing system to perform operations comprising:
recording an artificial intelligence (AI) agent interacting with a user interface, wherein the interaction includes the AI agent performing a plurality of actions of a first task;
based on the recording, identifying capabilities of the AI agent associated with the AI agent performing the plurality of actions of the first task;
receiving a natural language request to perform a second task; and
in response to receiving the request:
generating a flow based on a representation of a subset of the capabilities; and
executing the flow in order to perform the second task.

15. The non-transitory computer-readable medium of claim 14, wherein generating the flow comprises:
identifying the subset of the stored capabilities based on similarities between the natural language request and capabilities of a database of capabilities; and
applying a representation of the subset of the capabilities to the AI model to generate the flow.

16. The non-transitory computer-readable medium of claim 15, wherein the capabilities of the AI agent are stored in a non-transitory memory that also includes a record of dependencies between capabilities in the non-transitory memory, and wherein applying a representation of the subset of the capabilities to the AI model to generate the flow comprises applying, to the AI model, a representation of (i) the subset of the capabilities and (ii) at least one capability that, according to the record of dependencies, is depended upon by at least one capability of the subset to generate the flow.

17. The non-transitory computer-readable medium of claim 14, wherein executing the flow includes performing at least one capability of the subset of capabilities to take at least one action of the plurality of actions of the first task via the user interface.

18. A system comprising:
one or more processors; and
memory, containing program instructions that, upon execution by the one or more processors, cause the system to perform operations comprising:
recording an artificial intelligence (AI) agent interacting with a user interface, wherein the interaction includes the AI agent performing a plurality of actions of a first task;
based on the recording, identifying capabilities of the AI agent associated with the AI agent performing the plurality of actions of the first task;
receiving a natural language request to perform a second task; and
in response to receiving the request:
generating a flow based on a representation of a subset of the capabilities; and
executing the flow in order to perform the second task.

19. The system of claim 18, wherein generating the flow comprises:
identifying the subset of the capabilities of the AI agent based on similarities between the natural language request and capabilities of a database of capabilities; and
applying a representation of the subset of the capabilities to an AI model to generate the flow.

20. The system of claim 19, wherein the non-transitory memory also includes a record of dependencies between capabilities in the non-transitory memory, and wherein applying a representation of the subset of the capabilities to the AI model to generate the flow comprises applying, to the AI model, a representation of (i) the subset of the capabilities and (ii) at least one capability that, according to the record of dependencies, is depended upon by at least one capability of the subset to generate the flow.
